(19) United States
(12) Patent Application Publication
(10) Pub. No.: US 2024/0052167 A1
(43) Pub. Date: Feb. 15, 2024

(54) MOLD FORMULATIONS FOR METAL ADDITIVE MANUFACTURING

(71) Applicant: Tritone Technologies Ltd., Rosh HaAyin (IL)

(72) Inventors: Hagai PELED, Tel-Aviv (IL); Olga NAKHMANOWICH, Oranit (IL)

(73) Assignee: Tritone Technologies Ltd., Rosh HaAyin (IL)

(21) Appl. No.: 18/266,005

(22) PCT Filed: Dec. 9, 2021
(86) PCT No.: PCT/IL2021/051477

§ 371 Date: Jun. 8, 2023

Related U.S. Application Data
(60) Provisional application No. 63/122,967, filed on Dec. 9, 2020.

(51) Int. Cl. C08L 91/08; B29C 64/112; B22F 3/22

(52) U.S. Cl. CPC C08L 91/08; B29C 64/112; B22F 3/225; B33Y 70/00

(57) ABSTRACT

A mold material formulation usable as mold material in a cast-mold process, in combination with a cast material formulation, is provided. The mold material formulation comprises a paraffin wax, a vegetable-based (natural) wax and a Fisher-Tropsh wax, as described and defined in the specification. Methods employing the formulation and objects and products obtained therefrom are also provided.

### RELATED APPLICATION/S

This application claims the benefit of priority under 35 USC § 119(e) of U.S. Provisional Patent Application No. 63/122,967 filed on Dec. 9, 2020, the contents of which are incorporated herein by reference in their entirety.

### FIELD AND BACKGROUND OF THE INVENTION

The present invention, in some embodiments thereof, relates to additive manufacturing, and, more particularly, but not exclusively, to novel mold formulations that are usable, for example, in layerwise mold-casting additive manufacturing of three-dimensional objects such as, but not limited to, mold-casting additive manufacturing that utilizes sinterable materials.

Additive manufacturing (AM), or solid freeform fabrication (SFF), is generally a process in which a three-dimensional (3D) object is manufactured utilizing a computer model of the objects. The basic operation of any AM system consists of slicing a three-dimensional computer model into thin cross sections, translating the result into two-dimensional position data and feeding the data to control equipment which manufacture a three-dimensional structure in a layerwise (layer-by-layer) manner.

Various AM technologies exist, amongst which are stereolithography, digital light processing (DLP), and three-dimensional (3D) printing. Such techniques are generally performed by layer by layer deposition and solidification of one or more building materials.

In three-dimensional printing processes, for example, a building material is dispensed from a printing head having a set of nozzles to deposit layers on a receiving medium. Depending on the building material, the layers may then solidify, harden or cure, optionally using a suitable device.

Generally, in AM, three-dimensional objects are fabricated based on computer object data in a layerwise manner by forming a plurality of layers in a configured pattern corresponding to the shape of the objects. The computer object data can be in any known format, including, without limitation, a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD).

Each layer is formed by additive manufacturing apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by the building material, and which type of building material is to be delivered thereto. The decision is made according to a computer image of the surface.

Additive Manufacturing, or 3D printing, is widely used today to make prototype parts and for small-scale manufacturing.

A widely used technique is fused deposition modeling (FDM) in which a plastic filament is unwound from a coil, fused and passed through a nozzle to be laid down as flattened strings to form layers from which a 3D object eventually emerges. Another technique that is used is stereolithography, in which an ultraviolet (UV) laser is focused onto a vat of photopolymer resin. With the help of computer aided manufacturing or computer aided design software (CAM/CAD), the UV laser is used to draw a pre-programmed design or shape onto the surface of a photopolymer vat, which is thereby solidified and forms a single layer of the desired 3D object. The process is repeated for each layer of the design until the 3D object is complete. Selective Laser Sintering SLS is another additive manufacturing layer technology, and involves the use of a high power laser, for example, a carbon dioxide laser, to fuse small particles of plastic into a mass that has a desired three-dimensional shape.

Additive Manufacturing technologies are in general slow compared to conventional production processes such as machining etc., due to the building process of forming the part layer by layer.

Furthermore, there are certain shapes that cannot be achieved by straightforward Additive Manufacturing. Some of these shapes can be achieved by printing out support areas that are later removed.

Metal and ceramic materials are more difficult to use in additive manufacturing procedures, primarily due to their relatively high melting temperatures.

A metal printing technique which is widely used is the DMLS— Direct Metal Sintering Laser. A very thin layer of metal powder is spread across the surface that is to be printed. A laser is slowly and steadily moved across the surface to sinter the powder. Additional layers of powder are then applied and sintered, thus “printing” the object one cross-section at a time. In this way, DMLS gradually builds up a 3D object through a series of very thin layers.

Another method of 3D metal printing is selective laser melting (SLM), in which a high-powered laser fully melts each layer of metal powder rather than just sintering it. Selective laser melting produces printed objects that are extremely dense and strong. Selective laser melting can only be used with certain metals. The technique can be used for the additive manufacturing of stainless steel, tool steel, titanium, cobalt, chrome, and aluminum parts. Selective laser melting is a very high-energy process, as each layer of metal powder must be heated above the melting point of the metal. The high temperature gradients that occur during SLM manufacturing can also lead to stresses and dislocations inside the final product, which can compromise its physical properties.

Electron beam melting (EBM) is an additive manufacturing process that is very similar to selective laser melting. Like SLM, it produces models that are very dense. The difference between the two techniques is that EBM uses an electron beam rather than a laser to melt the metal powder. Currently, electron beam melting can only be used with a limited number of metals. Titanium alloys are the main starting material for this process, although cobalt chrome can also be used.

The above-described metal printing technologies are expensive, very slow, and limited by build size and materials that can be used.

Binder Jet 3D-Printing is widely used to print sand molds for castings or to generate complex ceramic parts. It is also known as a Metal Additive Manufacturing technology. Instead of melting the material, as is done in Selective Laser Melting (SLM) or Electron Beam Melting (EBM), the metal powders are selectively joined by an adhesive ink. The thus obtained “green” part, or “green body” is afterwards subjected to thermal processes—debinding and sintering and in some cases also infiltration of additional materials.

A technique for printing of ceramics is disclosed in Ceramics 3D Printing by Selective Inhibition Sintering—Khoshnevis et al., in which, as with metal, an inhibition material forms a boundary defining edges around a ceramic powder layer which is then sintered. The inhibition layer is subsequently removed.

U.S. Patent Application Publication No. 2014/0339745A1 to Stuart Uram, discloses a method of making an object using mold casting methodology which comprises applying a slip mixture into a mold fabricated using Additive Manufacturing and then firing the mold with the mixture inside.

Powder Injection Molding (PIM) is a process by which finely-powdered metal (in MIM—Metal Injection Molding) or ceramic (in CIM—Ceramic Injection Molding) is mixed with a measured amount of binder material to comprise a feedstock capable of being handled by injection molding. The molding process allows dilated complex parts, which are oversized due to the presence of binder agent in the feedstock, to be shaped in a single step and in high volume.

After molding, the powder-binder mixture is subjected to debinding steps that remove mold and the binder, and sintering, to densify the powders. End products are small components used in various industries and applications. The nature of the PIM feedstock flow is defined using rheology. Current equipment capability requires processing to stay limited to products that can be molded using typical volumes of 100 grams or less per shot into the mold. The variety of materials capable of implementation within PIM feedstock is broad. Subsequent conditioning operations are performed on the molded shape, where the binder material is removed and the metal or ceramic particles are diffusion bonded and densified into the desired state with typically 15% shrinkage in each dimension. Since PIM parts are made in precision injection molds, similar to those used with plastic, the tooling can be quite expensive. As a result, PIM is usually used only for higher-volume parts.

A use of a printable mass containing a paste made of a metal powder and a binder in 3D-screen printing has been practiced by the Fraunhofer Institute for Manufacturing Technology and Advanced Materials. See, for example, www(dot)ifam-dd(dot)fraunhofer(dot)de.

3D metal printing using solvent-free water-based metal, ceramic or support paste is described in www(dot)rapidia(dot)com. Printed objects are transferred directly to a furnace for sintering and polymeric support materials evaporate during sintering.

WO 2018/203331, by the present assignee, discloses a way of carrying out Additive Manufacturing using ceramics and metals that is relatively fast, capable of creating complex geometries and compatible with a large variety of materials. The methodology disclosed therein combines Additive Manufacturing with molding techniques in order to build shapes that have hitherto not been possible with conventional molding or machining technologies or in order to use materials that are difficult or impossible to use with known Additive Manufacturing technologies, or to build shapes faster than is possible with known Additive Manufacturing technologies. In examples, Additive Manufacturing is used to make a mold and then the mold is filled with the material of the final product. In some variants, layers of the final product are separately constructed with individual molds, where a subsequent layer is made over a previously molded layer. The previously molded layer may in fact support the mold of the new layer, as well as provide the floor for the new layer. This methodology is also referred to as cast-mold, or mold-casting, methodology, or as layerwise cast-mold or mold-casting methodology.

In one variant, a printing unit is provided which has a first nozzle for 3D printing material to form the mold, and a second, separate, nozzle to provide the filler. The second nozzle may be adjusted to provide different size openings to fill different sized molds efficiently. In other variants two separate applicators are provided, one for printing the mold and having three degrees of freedom as needed for 3D printing, and one for filling the mold after it has been formed.

One variant comprises the use of inkjet print heads to print the mold using wax or any other hot melt or thermo-set material, and the possibility to level the paste cast deposited layer by use of a self-leveling cast material. An alternative for leveling the cast is by vibrating the cast material just after molding, and a further alternative comprises using mechanical tools such as squeegee or blade and to fill and level the mold.

In this variant, the metal or ceramic paste is in liquid form, and is applied within the mold by means of a doctor blade or a squeegee and forms a thin layer. A planning process machines the hardened paste using a cutter or planer to form a smooth surface.

Prior to planning, the paste may undergo a drying process. In the drying process, part of the liquids in the paste may be removed, and it is desirable that drying is relatively quick so as not to slow down manufacture of the part. Additive manufacture is in any case a relatively slow process and anything that can speed it up is desirable.

WO 2020/044336, also by the present assignee, discloses an improvement of the method taught in WO 2018/203331, by utilizing vacuum to assist drying and more particularly to carry out hardening of the paste or other filling used in the mold to form the layer. More particularly, at each layer the mold is formed and then filled with a paste or other substance, and then the newly filled layer surface is placed in a vacuum so that the pressure quickly falls to change the boiling points of the liquids in the layer. The liquids thus evaporate to harden the layer, without affecting the physical state or mechanical properties of the mold (e.g., without causing melting and/or thermal expansion rate) in each layer. After hardening, the vacuum is released, and the volume is vented. In some of the embodiments disclosed in WO 2020/044336, the additive manufacturing of a product comprises: printing a first mold to define one layer of said product; filling said first mold with a paste material, thereby forming a first layer; sealing the layer in a sealing hood; applying a vacuum to the sealing hood; retaining the vacuum for a predetermined duration; removing the vacuum following said retaining; removing the seal; and printing successive further layers, each over a respective preceding layer, for each layer repeating said printing a mold, filling with paste, sealing, applying a vacuum, removing the vacuum and removing the seal; thereby to form a molded layered green body, which can thereafter be subjected to debinding and sintering processes to provide the final product.

WO 2020/129049, by the present assignee, discloses an additive manufacturing using sinterable materials which requires use of sintering supports, and which comprises producing a support component with a shape complementary to the product or part, also with a process using additive manufacture; and supporting the product or part during the sintering by fitting the product or part into the complementary shape. The support component is preferably made from a material selected to have a melting point which is higher than a sintering temperature of the product or part and/or having a coefficient of expansion which is close to a coefficient of expansion of the product or part at the sintering temperature.

WO 2020/225591, by the present assignee, discloses a sinterable paste formulation usable as cast material in a cast-mold process in combination with a mold material formulation, which comprises a powder of a sinterable material, a binder and an aqueous solution, wherein an amount of the powder is at least 85% by weight of the total weight of the formulation, and wherein the aqueous solution comprises water and a water-miscible organic solvent, wherein the organic solvent has an evaporation rate in a range of from 0.3 to 0.8 on an n-butyl acetate scale.

WO 2021/234707, by the present assignee, describes a method of forming a base for additive manufacture in order to print an object or part object on the wax base which involves forming the wax base on a printing tray. The base is constructed by providing a layer of wax on a surface of the printing tray. The wax is heated to above a melting point thereof so that the wax in contact with the tray is molten, and then the wax is slowly cooled while continually pressing on the wax. The slow cooling ensures a bond between the wax and the printing tray which may be enhanced if the tray surface is roughened.

PCT/IL2021/051349, filed Nov. 11, 2021, discloses a sinterable paste formulation usable as cast material in a cast-mold process, in combination with a mold material formulation. The sinterable paste formulation comprises a power of a sinterable material, in an amount of at least 85% by weight of the total weight of the formulation, a binder material and an organic vehicle, and is preferably devoid of water.

PCT/IL2021/051180, filed Sep. 30, 2021, by the present assignee, discloses a method of printing layers using a plurality of printheads, to achieve a printed surface of even thickness by compensating for printing density differences between the printheads, The method is effected by obtaining for each of the print heads a relative printing strength, calculating a compensation value for each print head; and carrying out printing of a layer, wherein each print head is operated according to the compensation value. The described method is usable for printed layers that form a part of the mold in a mold-cast process.

The contents of WO 2018/203331, WO 2020/044336, WO 2020/129049, WO 2020/225591, WO 2021/234707, PCT/IL2021/051349 and PCT/IL2021/051180, are incorporated by reference as if fully set forth herein.

In the above-mentioned patent applications, the mold formulation is described as being a thermoset material, featuring a melting point in a range of from 50 to 250° C., with exemplary mold materials being mineral wax, acrylic, epoxy or urethane-based polymers, polyolefins, oxidized wax and/or micronized wax.

### SUMMARY OF THE INVENTION

According to an aspect of some embodiments of the present invention there is provided a novel mold material formulation usable as forming a mold material in a cast-mold process in combination with a cast material formulation.

According to embodiments of this aspect of the present invention, the mold material formulation comprising:
Microcrystalline paraffin wax featuring a viscosity lower than 1000 cps at 90° C. and a melting temperature lower than 70° C. or lower than 60° C., in an amount of from about 40 to about 70 weight percent of the total weight of the formulation;
Vegetable-based (natural) wax featuring a low thermal expansion coefficient and high thermal conductivity, and optionally featuring an acid number higher than 1, or higher than 2, or higher than 5; in an amount of from about 30 to about 50 weight percent of the total weight of the formulation; and
Fisher-Tropsh wax, in an amount of from about 1 to about 10 weight percent of the total weight of the formulation.

According to some of any of the embodiments of the present invention, the microcrystalline paraffin wax features a melting point range lower than 10 or lower than 8 or lower than 6, ° C.

According to some of any of the embodiments of the present invention, the microcrystalline paraffin wax features an acid number lower than 2, or lower than 1.

According to some of any of the embodiments of the present invention, the vegetable-based wax features a linear thermal expansion lower than 1%, when determined by a method as described herein in the Examples section.

According to some of any of the embodiments of the present invention, the vegetable-based wax features thermal conductivity higher than 0.25, or higher than 0.30 or higher than 0.40 (e.g., from 0.25 to 0.5 W/m ° C.).

According to some of any of the embodiments of the present invention, the vegetable-based wax features an acid number higher than 10.

According to some of any of the embodiments of the present invention, an amount of the Fisher-Tropsh wax ranges from 2 to 8, of from 2 to 6, weight percent of the total weight of the formulation.

According to some of any of the embodiments of the present invention, the mold material formulation according to any of the embodiments described herein in characterized by a Viscosity in a range of from about 6 to about 15 centipoises, at a temperature in a range of from 70 to 90° C.; and as providing a mold material that is characterized by at least one, or at least two, or at least three, or at least four, or all, of the following characteristics: Melting point lower than 80° C., or lower than 70° C., for example, of from 50 to 80° C., or from 60 to 80° C., or from 50 to 70° C., or from 55 to 65° C.; Melting point range lower than 10° C.; Softening point in a range of from 35 to 50° C.; Linear thermal expansion at 25-100° C. lower than 0.5%; Thermal conductivity of at least 0.25, or at least 0.30 or at least 0.40; Cohesion; High Flexural strength; Dissolvability in an aliphatic hydrocarbon solvent; and Thermolysis at a temperature that ranges from 180 to 600° C., as these properties are defined, described and determined as described herein.

According to some of any of the embodiments of the present invention, the mold material formulation is further characterized by one or more of the following characteristics: Surface tension in a range of from about 24 to about 30 dyne/cm (e.g., of about 28 dyne/cm); being devoid of solid particles having a diameter higher than 2 microns, or higher than 1 micron; and/Chemical inertness and stability during the mold-cast process, as these properties are defined, described and determined as described herein.

According to some of any of the embodiments of the present invention, the mold material provided by the formulation is further characterized by one or more of the following characteristics: Machinability at the mold-cast process conditions; Plasticity resistance at the mold-cast process conditions; Adhesion to a cast material usable in the mold-cast process; and Low curling, as these properties are defined, described and determined as described herein.

According to some of any of the embodiments of the present invention, the mold material formulation is usable in forming a mold in a configured pattern in an additive manufacturing process such as 3D inkjet printing.

According to some of any of the embodiments of the present invention, the mold material formulation further comprises one or more additives, as described herein, for example, an antioxidant, a dye or pigment, or a combination thereof.

According to an aspect of some embodiments of the present invention there is provided a method of forming a three-dimensional object, the method comprising: forming a mold according to a shape of the object, using a mold material formulation as described herein in any of the respective embodiments and any combination thereof; filling the mold with a cast material formulation (e.g., as described herein), to thereby obtain a mold-cast product; and removing the mold from the mold-cast product, to thereby obtain the object.

According to some of any of the embodiments of the present invention, the filling comprises pouring the cast material formulation into the mold.

According to some of any of the embodiments of the present invention, the filling comprises injection molding of the cast material formulation into the mold.

According to some of any of the embodiments of the present invention, the filling comprises using a squeegee pressed against the mold to spread the sinterable formulation into the mold, or wherein the filling comprises using a blade spaced from the mold surface to spread the sinterable formulation into the mold.

According to some of any of the embodiments of the present invention, removing the mold comprises immersion in an organic solvent at a temperature in a range of from 30 to 100° C.

According to some of any of the embodiments of the present invention, the organic solvent is or comprises an aliphatic hydrocarbon.

According to some of any of the embodiments of the present invention, the method further comprises, prior to removing the mold, hardening the mold-cast product.

According to some of any of the embodiments of the present invention, forming the mold comprises forming a layered mold by dispensing a plurality of layers of the mold material formulation in a configured pattern corresponding to the shape of the object.

According to some of any of the embodiments of the present invention, the method comprises: printing a first layer of the mold material to define one layer of the layered mold; filling the first mold with the cast material formulation, thereby forming a first mold-cast layer; printing a second layer of the mold on top of the first mold-cast layer to define a second layer of the layered mold; and filling the second layer, over the first layer, with the cast material formulation.

According to some of any of the embodiments of the present invention, the method further comprises finishing the first layer after forming and prior to printing the second mold; thereby to form the second layer on the finished surface of the first layer.

According to some of any of the embodiments of the present invention, the method further comprises, subsequent to the filling, hardening the mold-cast layer.

According to some of any of the embodiments of the present invention, the hardening comprises subjecting the mold-cast layer or object to a reduced pressure for a pre-determined time period.

According to some of any of the embodiments of the present invention, the method further comprises, prior to subjecting to a reduced pressure, applying hot air to the mold-cast layer or object.

According to some of any of the embodiments of the present invention, the reduced pressure ranges from 0.01 millibar to 100 milliBar, or from 0.1 millibar to 25 millibar, or about one millibar.

According to some of any of the embodiments of the present invention, the pre-determined time period ranges from 10 to 150 seconds, or is about thirty seconds.

According to some of any of the embodiments of the present invention, the cast material formulation comprises a sinterable material.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Operation of the 3D printing device of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified flow chart illustrating a procedure for producing a layered molded product or part according to some embodiments of the present invention;

FIG. 1B is a simplified flow chart showing a more detailed embodiment of the procedure of FIG. 1A;

FIG. 2 is a simplified flow chart illustrating a procedure for hardening a layer formed from a cast material is a form of a paste spread into a mold according to an exemplary embodiment of the present invention;

FIG. 3 is a simplified flow chart showing a variation of the procedure of FIGS. 1A-B in which certain hardening phases are repeated for individual layers; and

FIG. 4 is a simplified flow chart illustrating a procedure for producing a layered molded product or part according to some embodiments of the present invention.

FIGS. 5A-B present photographs of exemplary mold objects prepared using an exemplary mold formulation according to the present embodiments (FIG. 5A) compared to a mold formulation which exhibits poor cohesion (FIG. 5B).

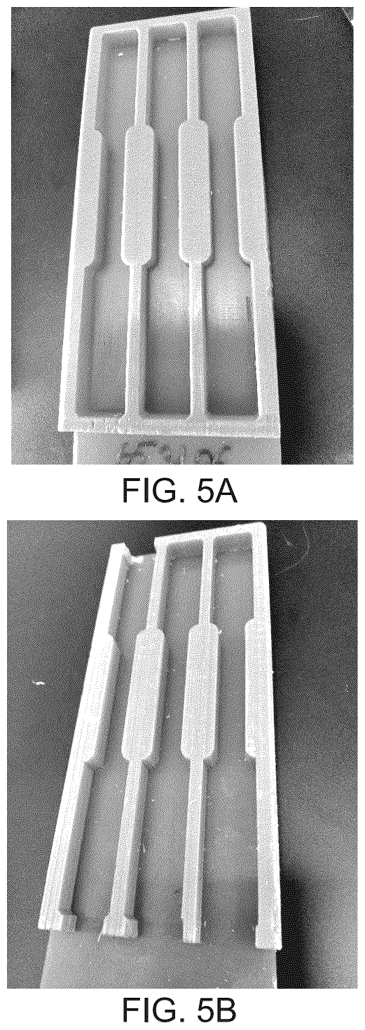

### DESCRIPTION OF SPECIFIC EMBODIMENTS OF THE INVENTION

The present invention, in some embodiments thereof, relates to additive manufacturing, and, more particularly, but not exclusively, to novel mold formulations that are usable, for example, in layerwise mold-casting additive manufacturing of three-dimensional objects such as, but not limited to, mold-casting additive manufacturing that utilizes sinterable materials.

As discussed in the Background section hereinabove, additive manufacturing of three-dimensional objects containing in at least a portion thereof metal and/or ceramic materials is highly advantageous over methodologies such as machining and rapid prototyping manufacturing, yet pose some challenges in rendering the AM process efficient. Some of the currently practiced processes of AM of objects made of metals and/or ceramics employ metal/ceramic powders, possibly in a form of metal/ceramic paste that further comprises a binder.

An efficient additive manufacturing of objects made of metals and/or ceramics by a layerwise mold-casting process has been disclosed recently and is described in WO 2018/203331, WO 2020/044336, WO 2020/129049, WO 2020/225591, WO 2021/234707, PCT/IL2021/051349 and PCT/IL2021/051180, all by the present assignee. The methodology disclosed in these patent applications combines Additive Manufacturing with molding techniques. In examples, Additive Manufacturing is used to make a mold, using a mold material, and then the mold is filled with the material of the final product (a cast material). The cast material can include a sinterable material, such as, for example, a metal or ceramic powder. In some variants, layers of the final product are separately constructed with individual molds, where a subsequent layer is made over a previously molded layer. The previously molded layer may in fact support the mold of the new layer, as well as provide the floor for the new layer.

In one variant, a printing unit is provided which has a first nozzle for 3D printing material, which dispenses a mold material to form the mold, and a second, separate, nozzle to provide the filler (the cast material). The second nozzle may be adjusted to provide different size openings to fill differently sized molds efficiently. In other variants two separate applicators are provided, one for printing the mold by dispensing a mold material and having three degrees of freedom as needed for 3D printing, and one for filling the mold after it has been formed with the cast material.

One variant comprises the use of inkjet print heads to print the mold using a mold material, and the possibility to level the deposited layer of the cast material, when it is in a form of a paste, by use of a self-leveling cast material. An alternative for leveling the cast material is by vibrating the cast material just after molding, and a further alternative comprises using mechanical tools such as squeegee or blade to fill and level the mold material and/or the cast material.

In this variant, the cast material, which is, for example, a metal or ceramic paste, is in liquid form, and is applied within the mold by means of a doctor blade or a squeegee and forms a thin layer. A planning process machines the hardened paste using a cutter or planer to form a smooth surface.

Prior to planning, the paste may undergo a drying process. In the drying process, part of the liquids in the paste may be removed, and it is desirable that drying is relatively quick so as not to slow down manufacture of the part, for example, as disclosed in WO 2020/044336.

A cast material formulation which comprises sinterable material(s), and which is suitable for use in this methodology is described in WO 2020/225591.

In a mold-casting process such as described, for example, in WO 2018/203331, WO 2020/044336, and WO 2020/225591, a mold material is digitally printed to form a first mold layer, which is then filled with the cast material. The cast layer is thereafter dried, typically using hot air or under vacuum (e.g., as described in WO 2020/044336), and another mold layer is deposited, etc. During the layerwise deposition of mold and cast materials, to form a green body, faults and/or defects in one or more layers are sometimes detected, and require peeling off the fault layer, typically by mechanical means such as mechanical grinding using a device such as a planner.

At the end of the process the cast material is separated from the mold material, typically by immersing the mold/cast green body in a liquid in which the mold material is dissolvable, and/or by subjecting the green body to a temperature at which the mold material melts. Residues of the mold material may be removed during the following thermal treatment of debinding and sintering, that the cast material is passes through.

Herein, and in the art, the phrases “mold cast process”, “mold casting process”, “mold-cast method”, “mold casting method”, “mold cast methodology”, “mold casting methodology” and any other phrases that relate to a combination of a mold and a cast, describe a process in which a mold, typically a sacrificial mold, is formed while surrounding at least one free space, and the at least one free space is filled with a dispensable (e.g., flowable, flowing) cast material. Once the cast material is at least partially hardened, such that it is hard enough to be self-supporting and/or maintain its shape, the mold is removed. Typically, mold-cast methodologies further include an additional step of further hardening the cast material.

Herein, the phrase “mold material” describes a material used to a form a mold. When the mold material hardens during the process, this phrase relates to the hardened mold material, and the pre-hardened material that is dispensed to provide the mold material is referred to as mold material formulation or as a mold formulation. In some embodiments, the hardening of a mold material formulation does not change the chemical composition of the material, in which cases, the phrases “mold material formulation” and “mold material” are used interchangeably.

The phrase “cast material formulation” or “cast formulation” as used herein describes the material that fills the mold, before it is hardened. The phrase “cast material” describes the hardened form of the cast material formulation (e.g., in a green body, as defined herein).

The phrase “green body” as used herein describes an object formed by an additive manufacturing (AM) process that has at least a portion that only been partially hardened or solidified and requires additional hardening to obtain a fully solidified object. Typically, but not obligatory, a green body is a self-supported body that is capable of maintaining its geometrical shape. In the context of the present embodiments, the green body relates to the object prepared by AM using a mold-cast methodology, and upon removal of the mold material.

The phrase “brown body” as used herein and in the art describes an object prepared by a mold-cast process, after removal of the mold material and the binder (after debinding).

Herein throughout, the term “object” describes a product of an additive manufacturing process or a mold-cast process. The term “product” refers to a final product in which sinterable materials underwent sintering or any other process to fuse the powder materials. The product can be a final article-of-manufacturing or a part thereof.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

In extensive studies conducted for further improving the efficiency and accuracy of a layerwise mold-casting additive manufacturing such as described hereinabove, the present inventors have uncovered that in order to effectively meet the requirements of the above-mentioned process, a mold material should exhibit properties that allow it to be printable, to successfully perform during the layerwise mold-cast process, and to be efficiently and successfully removed during the post-process treatment for providing the green body and optionally the brown body to thereby provide the final product.

More specifically, the mold material should feature the following properties:

I. For the process step at which the mold material is dispensed to form a mold layer in a configured pattern, the mold material should exhibit good printability in terms of viscosity, surface tension, melting point, chemical stability (e.g., thermal stability), and chemical compatibility, that allow dispensing it in a configured pattern to form the mold layers.

Considering an additive manufacturing methodology that uses a three-dimensional inkjet printing system, the mold material should preferably exhibit the following:
Viscosity in a range of from about 6 to about 15 centipoises, at the jetting temperature (typically 70-120° C., or 70-100° C., or 70-90° C.);
Surface tension in a range of from about 24 to about 30 dyne/cm (e.g., of about 28 dyne/cm);
Stability at the jetting temperature (e.g., as described herein);
Melting point lower by at least 10° C. than the jetting temperature, for example, lower than 80° C., or lower than 70° C., for example, of from 50 to 70° C., or from 55 to 70° C., or from 55 to 65° C.;
Being devoid of solid particles having a diameter higher than 2 microns, or higher than 1 micron (so as to avoid clogging of inkjet printing heads);
and
Chemical inertness with the printheads and nozzles thereof at the jetting temperature as described herein.

II. For the process steps at which the layerwise fabrication of successive mold-cast layers is performed, the mold material should preferably exhibit adhesion to the cast material; adhesion between the mold layers (adhesion of one mold layer to a previous (if present) and a subsequent (if present) mold layer); and machinability, that is, high rigidity at the working temperature, high plasticity resistance (resistance to deformation at the working temperature and conditions), and mechanical stability when subjected to, for example, planning and other process steps that may be required during the layerwise fabrication. These parameters are further described and defined in the Examples section that follows.

In addition to the above, the mold material should exhibit chemical and mechanical stability, and good thermal conductivity during the step of drying the cast material before deposition of a successive mold layer. More specifically, the mold material should exhibit a softening point that is higher than the temperature applied during the drying step; low thermal expansion; low curling at the drying temperature; high thermal conductivity; high flexibility; and plasticity resistance at the drying temperature.

The mold material should preferably exhibit the following:
Softening point higher than 35° C., for example, from about 35 to about 50, ° C.;
Sharp melting point (e.g., a melting point range lower than 20° C. or lower than 10° C.)
Linear Thermal expansion at 25-100° C., lower than 1% or lower than 0.5%, determined as described in the Examples section that follows;
Low curling (e.g., when measured as described in the Examples section that follows);
Thermal conductivity of at least 0.25, or at least 0.30 or at least 0.40 W/m ° C.;
Flexibility;
and plasticity resistance.

III. For the post-treatment of the green body obtained in the layerwise cast-mold AM, a mold material should exhibit properties that would allow complete removal, without affecting the mechanical and chemical properties of the final product (e.g., the final product that is made of sinterable materials). Thus, a mold material should exhibit good dissolvability in a non-hazardous organic solvent and should also be non-toxic, and environmentally friendly by itself; and in addition it should undergo complete thermal decomposition and complete evaporation of its thermolysis products during the sintering or any other post-treatment procedure that is effected at elevated temperatures.

The mold material should preferably exhibit the following:

Dissolvability in an organic solvent such as a saturated aliphatic hydrocarbon or a mixture of such hydrocarbons, for example, propane, butane, pentane, hexane, heptane, octane, nonane, Decane and/or higher alkyls (e.g., up to 30 or 40 carbon atoms in length), as well as commercially available petroleum solvents such as, for example, Isopar-M or Isopar-L. A suitable organic solvent is such that when the mold material contacts an equal weight of the organic solvent, at a temperature in a range of from room temperature to about a temperature higher than the melting point of the formulation (e.g., 70° C. or higher, and up to about 90 or 100° C.), at least 50% m preferably at least 60%, or at least 70%, or at least 80%, or at least 90%, or nearly 100%, of the mold material dissolves; and/or

Complete thermolysis at a temperature in a range of from 180 to 600, preferably thermolysis into materials that evaporate at the indicated temperatures range.

The present inventors have thus realized that a mold material that is suitable for use in a mold-casting additive manufacturing, particularly of a process that utilizes sinterable materials such as metal powders and ceramics, should exhibit at least some and preferably all of the following characteristics:
Viscosity in a range of from about 6 to about 15 centipoises at the jetting temperature (e.g., as described herein);
Surface tension in a range of from about 24 to about 30 dyne/cm;
Stability at the jetting temperature, as described herein;
Melting point lower by at least 10° C. than the jetting temperature (e.g., of from about 50 to about 80° C.);
Chemical inertness with the printheads and nozzles thereof at the jetting temperature;
Being devoid of solid particles having a diameter higher than 2 microns, or higher than 1 micron (so as to avoid clogging of inkjet printing heads and/or nozzles);
Good cohesion and good adhesion to the cast material formulation (e.g., as described herein in any of the respective embodiments and any combination thereof),
and as providing a mold material that exhibits at least some and preferably all of the following characteristics:
Machinability; rigidity; plasticity resistance, as described and defined herein;
Softening point of from about 35 to about 50° C.;
Sharp melting point, as described herein;
Linear Thermal expansion at 25-100° C. lower than 0.5%, determined as described herein;
Low curling (e.g., determined as described herein);
Thermal conductivity as described herein;
Flexural strength as described herein;
Dissolvability in an organic solvent as described and defined herein; and/or
Complete thermolysis at a temperature in a range of from 180 to 600, preferably thermolysis into materials that evaporate at the indicated temperatures range.

Reference is made to the Examples section that follows, for methods of determining the above properties and respective desirable values.

During extensive and laborious studies conducted for uncovering mold material formulations/compositions that exhibit at least some and preferably all of the above properties, dozens of mold materials, including various combinations of materials such as wax materials, polymeric materials and others, the present inventors have uncovered that most of these formulations fail to exhibit the required combination of properties. The present inventors have found a unique combination of the wax materials that, contrary to other materials and combinations thereof, exhibits all of the identified properties that are required for adequate performance in a mold-casting process as described herein.

Embodiments of the present invention therefore relate to novel mold material formulations that are suitable for use, or are usable, in a mold-casting process as described herein, to mold-casting processes utilizing same and to objects prepared by such processes.

The novel mold material formulations are usable, in some embodiments, in additive manufacturing processes such as described in WO 2018/203331, WO 2020/044336, WO 2020/129049, and PCT/IL2021/051349 and/or in any other manufacturing processes where cast-mold methodologies are used.

The novel formulations are designed so as to meet the (e.g., additive) manufacturing process requirements in terms of dispensability through a selected nozzle or any other dispenser, fast hardening of each layer to allow an efficient process, while at the same time be chemically compatible with process requirements of other manufacturing steps such as removal of the mold material, debinding and sintering. In some embodiments, the novel formulations are designed so as to properly adhere both to the previous mold material and to the cast layer. In some embodiments, the novel formulations are designed so as to undergo drying under reduced pressure without affecting the homogeneity and/or dimensions of the mold material (e.g., without undergoing thermal shrinkage, for example, by featuring low linear thermal expansion). The novel formulations are also usable in other mold-casting processes.

In some of any of the embodiments described herein, in a mold-cast process, the mold is formed by an additive manufacturing process, and in some embodiments, the additive manufacturing is three-dimensional (3D) printing, for example, three-dimensional (3D) inkjet printing.

In some of any of the embodiments described herein, the mold-cast process comprises a layer-by-layer (layerwise) formation of a mold material wherein each layer of the mold material is filled with a cast material formulation, such as described, for example, in WO 2018/203331, WO 2020/044336, WO 2020/129049, and PCT/IL2021/051349 and is described in further detail hereinbelow.

The mold material formulation described herein can be used in any other mold-cast processes.

In some embodiments, the mold material formulation is usable in mold-cast processes in which hardening of the cast material formulation is performed under reduced pressure, as described in further detail hereinafter and in WO 2020/044336.

In some embodiments, the mold material formulation is usable in mold-cast processes in combination with a cast material formulation as described herein or in WO 2020/225591 or in PCT/IL2021/051349.

The Mold Material Formulation:

By “mold material formulation” it is meant herein a formulation that is used in the additive manufacturing process to form the mold material in a configured pattern. That, the mold material formulation is the formulation that is dispensed to form the mold, which is thereafter filled with a cast material in a mold-casting process such as described herein.

In some of any of the embodiments described herein, the mold material formulation and the mold material that forms the mold are of the same chemical composition. In some embodiments, the physical properties of the formulation are different from those of the material that forms the mold after dispensing, for example, while the dispensed formulation is liquid at the dispensing (e.g., jetting) temperature, the formed mold, once dispensed and subsequently cooled, is solid or at least semi-solid.

According to an aspect of some embodiments of the present invention there is provided a mold material formulation. In some embodiments, the mold material formulation is usable in mold casting processes, for example, mold casting processes as described in exemplary embodiments herein.

According to an aspect of some embodiments of the present invention there is provided a mold material formulation that exhibits at least five, at least six, and preferably all of the properties described hereinabove, namely:
Viscosity in a range of from about 6 to about 15 centipoises at the jetting temperature as described herein;
Surface tension in a range of from about 24 to about 30 dyne/cm;
Stability at the jetting temperature, as described herein;
Melting point lower by at least 10° C. than the jetting temperature (e.g., of from about 50 to about 80° C.;
Chemical inertness with the printheads and nozzles thereof at the jetting temperature;
Being devoid of solid particles having a diameter higher than 2 microns, or higher than 1 micron (so as to avoid clogging of inkjet printing heads);
Good cohesion and adhesion (e.g., as defined herein) to the cast material formulation (e.g., as described herein in any of the respective embodiments and any combination thereof),
and as providing a mold material that exhibits at least some and preferably all of the following characteristics:
Machinability; rigidity; plasticity resistance, as described and defined herein;
Softening point of from about 35 to about 50° C.;
Sharp melting point, as described herein;
Linear Thermal expansion at 25-100° C. lower than 0.5%, determined as described herein;
Low curling;
Thermal conductivity as described herein;
Flexural strength as described herein;
Dissolvability in an organic solvent as described and defined herein; and/or
Complete thermolysis at a temperature in a range of from 180 to 600, preferably thermolysis into materials that evaporate at the indicated temperatures range.

According to some of any of the embodiments described herein, the mold material formulation exhibits at least one, at least two, at least three, and preferably all of the following:
Viscosity in a range of from about 6 to about 15 centipoises at the jetting temperature as described herein;
Melting point lower by at least 10° C. than the jetting temperature (e.g., of from about 50 to about 80° C.;
Good cohesion and adhesion (e.g., as defined herein) to the cast material formulation (e.g., as described herein in any of the respective embodiments and any combination thereof),
and as providing a mold material that exhibits at least some and preferably all of the following characteristics:
Sharp melting point, as described herein;
Linear Thermal expansion at 25-100° C. lower than 0.5%, determined as described herein;
Thermal conductivity as described herein;
Flexural strength as described herein; and
Dissolvability in an organic solvent as described and defined herein.

According to an aspect of some embodiments of the present invention there is provided a mold material formulation which comprises:
Paraffin wax featuring a viscosity lower than 1000 cps at the jetting temperature (e.g., 70-90° C.) and a melting temperature lower than 70° C. or lower than 60° C.;
Vegetable-based (natural) wax featuring a low thermal expansion coefficient and high thermal conductivity; and Crystalline Fischer Tropsch wax.

By “wax” it is generally meant herein a hydrophobic material, which is solid at room temperature. Waxes can be derived from minerals or plants, or be synthetically prepared. Waxes typically comprise one or more compounds which are each independently a saturated or unsaturated hydrocarbon chain of at least 20 preferably at least 30, or at least 40 carbon atoms in length.

In some embodiments, the hydrocarbon consists of carbon and hydrogen atoms. In some embodiments, the hydrocarbon is 30, 32, 34, 36, 38, 40, or more carbon atoms in length.

By “Paraffin wax” it is meant herein a mineral wax, which is typically obtained by freezing or solvent dewaxing of petroleum fractions, and then deoiling and refining. Paraffin wax typically consists mainly of long alkylene chain(s), e.g., having at least 20, preferably at least 30, or at least 40 carbon atoms in length, which can be saturated and/or unsaturated, linear and/or branched, typically a mixture thereof.

In some of any of the embodiments described herein the paraffin wax is a microcrystalline wax, which has a viscosity as described herein.

In some of any of the embodiments described herein, the paraffin wax (e.g., microcrystalline paraffin wax) has a congealing point in a range of from 50 to 60° C.

In some of any of the embodiments described herein, the paraffin wax (e.g., microcrystalline paraffin wax) features needle penetration (e.g., as defined in the Examples section that follows) of 0.5-1.5 mm at 25° C.

In some of any of the embodiments described herein, the paraffin wax (e.g., microcrystalline paraffin wax) features a sharp melting point, namely, a melting point range lower than 10 or lower than 8 or lower than 6, ° C.

In some of any of the embodiments described herein, the paraffin wax (e.g., microcrystalline paraffin wax) features an acid number lower than 2, or lower than 1 (e.g., 0).

In some of any of the embodiments described herein, the paraffin wax is a microcrystalline paraffin wax, featuring a viscosity of lower than 1000 cps at the jetting temperature (e.g., 70-90° C.), a melting temperature lower than 70° C. or lower than 60° C., and melting point range lower than 10 or lower than 8 or lower than 6, ° C. In some of these embodiments, the paraffin wax features an acid number lower than 2 or lower than 1 (e.g. 0).

A non-limiting example of a suitable paraffin wax is marketed under the trade name Sasolwax® 5203.

By “vegetable wax” it is meant herein a natural wax material that is derived from one or more plants. “Vegetable wax” is also referred to herein as “natural wax” and encompasses wax substances that are obtainable from plants, or mixtures thereof with other wax substances, and/or synthetic analogs thereof.

In some of any of the embodiments described herein, the vegetable-based (natural) wax features a low thermal expansion coefficient. In some of these embodiments, the natural wax exhibits a linear thermal expansion lower than 1%, e.g., of from 0.1 to 1, or from 0.1 to 0.8, or from 0.2 to 0.8, or from 0.3 to 0.7, %, at 25-100° C., when determined as described in the Examples section that follows.

In some of any of the embodiments described herein, the vegetable-based (natural) wax features a high thermal conductivity. In exemplary embodiments, it features a thermal conductivity, as described herein, higher than 0.25, or higher than 0.3, or higher than 0.4, for example, of from 0.3 to 1, including any intermediate values and subranges therebetween.

In some of any of the embodiments described herein, the vegetable-based (natural) wax features a low thermal expansion coefficient and high thermal conductivity, as these terms are defined and described herein.

In some of any of the embodiments described herein, the vegetable-based (natural) wax features an acid number higher than 1, or higher than 2, or higher than 3, or higher than 4, or higher than 5, and optionally even higher than 10.

A non-limiting example of a natural wax suitable for inclusion in the mold formulation of the present embodiments is a candelilla wax, such as marketed by A. F. Suter & Co Ltd UK (see, Table 1). Another non-limiting example is a mixed natural wax such as marketed by Koster Keunen under the tradename KKH NatWax Alt 0154 (see, Table 1).

By “Fischer-Tropsch wax” it is meant herein a synthetic wax that is obtained by a Fischer-Tropsch process. It is typically mainly composed of straight-chain and saturated high-carbon alkanes with relative molecular weight of 500-1000 grams/mol. A non-limiting example is presented in Table 1 in the Examples section that follows. In some of any of the embodiments described herein, an amount (concentration) of the Paraffin wax is in a range of from 50 to 70% by weight, including any intermediate values and subranges therebetween, for example, from 50 to 60%, or from 50 to 55%, or from 50 to 53%, by weight, more preferably from 50 to 52% by weight, for example about 51% by weight (e.g., 51.1% by weight), of the total weight of the formulation; or from 60 to 70%, or from 60 to 65%, or from 62 to 65%, for example, from 63 to 64% (e.g., about 63.8%), by weight, of the total weight of the formulation.

In some of any of the embodiments described herein, an amount (concentration) of the vegetable-based wax is in a range of from 30 to 50% by weight, including any intermediate values and subranges therebetween, for example, from 40 to 50%, preferably from 42 to 48% by weight, more preferably from 43 to 45% by weight, for example about 44.5% by weight (e.g., about 44.4% by weight), of the total weight of the formulation; or from 30 to 40%, preferably from 30 to 35%, or from 31 to 34%, or from 32 to 33% (e.g., about 32.9%), by weight, of the total weight of the formulation.

In some of any of the embodiments described herein, an amount (concentration) of the Fischer-Tropsch wax is in a range of from 1 to 20% by weight, or from 1 to 10% by weight, or from 1 to 8% by weight, or from 2 to 20%, or from 2 to 10%, by weight, preferably from 1 to 5% by weight, more preferably from 2 to 5% by weight, more preferably from 2 to 4% by weight, for example about 3.7% by weight (e.g., 3.67% by weight) or about 2.5% by weight, of the total weight of the formulation.

In some of any of the embodiments described herein, an amount (concentration) of the Paraffin wax is in a range of from 50 to 55% by weight, preferably from 50 to 53% by weight, more preferably from 50 to 52% by weight, for example about 51% by weight (e.g., 51.1% by weight), of the total weight of the formulation; an amount (concentration) of the vegetable-based wax is in a range of from 40 to 50% by weight, preferably from 42 to 48% by weight, more preferably from 43 to 45% by weight, for example about 44.5% by weight (e.g., about 44.4% by weight), of the total weight of the formulation; and an amount (concentration) of the Fischer-Tropsch wax is in a range of from 1 to 8% by weight, preferably from 1 to 5% by weight, more preferably from 2 to 5% by weight, more preferably from 3 to 4% by weight, for example about 3.7% by weight (e.g., 3.67% by weight), of the total weight of the formulation.

In some of any of the embodiments described herein, an amount (concentration) of the Paraffin wax is in a range of from 50 to 55% by weight, an amount (concentration) of the vegetable-based wax is in a range of from 40 to 50% by weight, and an amount (concentration) of the Fischer-Tropsch wax is in a range of from 1 to 8% by weight, each of the total weight of the formulation.

In some of any of the embodiments described herein, an amount (concentration) of the Paraffin wax is in a range of from 50 to 53% by weight, an amount (concentration) of the vegetable-based wax is in a range of from 42 to 28% by weight, and an amount (concentration) of the Fischer-Tropsch wax is in a range of from 1 to 5% by weight, each of the total weight of the formulation.

In some of any of the embodiments described herein, an amount (concentration) of the Paraffin wax is in a range of from 50 to 52% by weight, an amount (concentration) of the vegetable-based wax is in a range of from 43 to 45% by weight, and an amount (concentration) of the Fischer-Tropsch wax is in a range of from 2 to 5% by weight, each of the total weight of the formulation.

In some of any of the embodiments described herein, an amount (concentration) of the Paraffin wax is about 51% by weight, an amount (concentration) of the vegetable-based wax is about 44.5% by weight, and an amount (concentration) of the Fischer-Tropsch wax is in a range of from 3 to 4% by weight, each of the total weight of the formulation.

In some of any of the embodiments described herein, an amount (concentration) of the Paraffin wax is about 51.1% by weight, an amount (concentration) of the vegetable-based wax is about 44.4% by weight, and an amount (concentration) of the Fischer-Tropsch wax is about 3.7% by weight, each of the total weight of the formulation.

In some of any of the embodiments described herein, an amount (concentration) of the Paraffin wax is in a range of from 60 to 65% by weight, preferably from 62 to 65% by weight, for example from 63 to 64% by weight (e.g., 63.78% by weight), of the total weight of the formulation; an amount (concentration) of the vegetable-based wax is in a range of from 30 to 40% by weight, preferably from 30 to 35% by weight, more preferably from 32 to 33% by weight, for example about 33% by weight (e.g., about 32.9% by weight), of the total weight of the formulation; and an amount (concentration) of the Fischer-Tropsch wax is in a range of from 1 to 5% by weight, preferably from 2 to 5% by weight, more preferably from 2 to 3% by weight, for example about 2.5% by weight (e.g., 2.55% by weight), of the total weight of the formulation.

In some of any of the embodiments described herein, an amount (concentration) of the Paraffin wax is in a range of from 60 to 65% by weight, an amount (concentration) of the vegetable-based wax is in a range of from 30 to 35% by weight, and an amount (concentration) of the Fischer-Tropsch wax is in a range of from 2 to 4% by weight, each of the total weight of the formulation.

In some of any of the embodiments described herein, an amount (concentration) of the Paraffin wax is in a range of from 62 to 65% by weight, an amount (concentration) of the vegetable-based wax is in a range of from 32 to 34% by weight, and an amount (concentration) of the Fischer-Tropsch wax is in a range of from 2 to 3% by weight, each of the total weight of the formulation.

In some of any of the embodiments described herein, an amount (concentration) of the Paraffin wax is in a range of from 63 to 64% by weight, an amount (concentration) of the vegetable-based wax is in a range of from 32 to 33% by weight, and an amount (concentration) of the Fischer-Tropsch wax is in a range of from 2 to 3% by weight, each of the total weight of the formulation.

In some of any of the embodiments described herein, an amount (concentration) of the Paraffin wax is about 64% by weight, an amount (concentration) of the vegetable-based wax is about 33% by weight, and an amount (concentration) of the Fischer-Tropsch wax is in a range of from 2 to 3% by weight, each of the total weight of the formulation.

In some of any of the embodiments described herein, an amount (concentration) of the Paraffin wax is about 63.8% by weight, an amount (concentration) of the vegetable-based wax is about 32.9% by weight, and an amount (concentration) of the Fischer-Tropsch wax is about 2.5% by weight, each of the total weight of the formulation.

In some of any of the embodiments described herein, a weight ratio of the paraffin wax and the natural wax ranges from 2:1 to 1:2, preferably from 2:1 to 1:1, including any intermediate values and subranges therebetween.

The present inventors have uncovered that when using other combinations of wax materials and/or different amounts or ratios of wax materials as described herein, the performance of mold material was unsatisfying at least in terms of viscosity, cohesion and/or adhesion, and curling, as exemplified in the Examples section that follows. The present inventors have uncovered that only with a mold formulation as described herein, the mold material formulation exhibits all the properties described hereinabove.

In some of any of the embodiments described herein, the mold material formulation further comprises one or more additives that may provide the formulation with, for example, improved stability and/or appearance. Such additives include, but are not limited to, antioxidants, adhesives, preservatives, coloring agents (dyes and/or pigments), surfactants, dispersant, plasticizer, rheology modifiers, and co-stabilizers.

In some of these embodiments, an amount of an additive is in a range of from 0.01 to 1% by weight, or from 0.01 to 0.8% by weight, or from 0.01 to 0.5% by weight, or from 0.1 to 1% by weight, or from 0.1 to 0.8% by weight, or from 0.1 to 0.5% by weight, of the total weight of the formulation.

In some of any of the embodiments described herein, the formulation further comprises an antioxidant, in an amount of from 0.1 to 0.8, or from 0.2 to 0.8, or from 0.2 to 0.7, of from 0.3 to 0.7, or from 0.4 to 0.6, or about 0.5, % by weight of the total weight of the formulation.

Exemplary antioxidants include, but are not limited to, phenol compounds, preferably those recognized as safe (e.g., categorized as GRAS), such as, for example, dibutylhydroxytoluene (BHT), BHA, Irgafos 1010, Irgafos 168 and similar compounds.

In some of any of the embodiments described herein, the formulation further comprises a dye, in an amount of from 0.1 to 0.8, or from 0.1 to 0.5, or from 0.2 to 0.5, of from 0.3 to 0.4, or about 0.55, % by weight of the total weight of the formulation.

In some of these embodiments, the dye is an oil-based dye and/or a dye that is soluble in organic solvents.

Exemplary dyes that are usable in the context of these embodiments include, but are not limited to, azo dyes which are yellow, orange, brown and red; anthraquinone and triarylmethane dyes which are green and blue; and azine dye which is black.

According to some of any of the embodiments described herein, a mold material formulation which comprises a paraffin wax, a vegetable-based wax and a crystalline Fischer-Tropsch wax, as described herein in any of the respective embodiments and any combination thereof, is such that exhibits at least five, at least six, and preferably all of the properties as delineated hereinabove.

According to some embodiments, a mold material formulation which comprises a paraffin wax, a vegetable-based wax and a crystalline Fischer-Tropsch wax, as described herein in any of the respective embodiments and any combination thereof, is such that exhibits a viscosity in a range of from about 6 to about 15 centipoises, at the jetting temperature (e.g., in a range of from 70 to 90° C.); and as providing a mold material that is characterized by at least one, or at least two, or at least three, or at least four, or all, of the following characteristics:
Melting point lower than 80° C., or lower than 70° C., for example, of from 50 to 80° C., or from 60 to 80° C., or from 50 to 70° C., or from 55 to 65° C.;
Melting point range lower than 10° C.; Softening point in a range of from 35 to 50° C.;
Linear thermal expansion at 25-100° C. lower than 0.5%, when determined as described herein;
Thermal conductivity of at least 0.25, or at least 0.30 or at least 0.40, e.g., of from 0.25 to 0.5, or from 0.3 to 0.5, W/m ° C.;
Cohesion (e.g., when determined as described herein);
High Flexural strength, e.g., higher than 2, or higher than 3, or higher than 4, MPa;
Dissolvability in an aliphatic hydrocarbon solvent as described herein; and
Thermolysis at a temperature that ranges from 180 to 600° C., as described herein.

In some embodiments, the formulation is further characterized by one or more of the following characteristics:
Surface tension in a range of from about 24 to about 30 dyne/cm (e.g., of about 28 dyne/cm); and
Chemical inertness and stability during the mold-cast process.

In some embodiments, the mold material provided by the formulation is further characterized by one or more of the following characteristics:
Machinability (e.g., as described herein) at the mold-cast process conditions;
Plasticity resistance at the mold-cast process conditions (e.g., as described herein);
Adhesion to a cast material usable in the mold-cast process (e.g., as described herein); and
Low curling (e.g., as described herein).

Mold-Casting Process:

According to an aspect of some embodiments of the present invention, there are provided processes of additive manufacturing an object (e.g., a three-dimensional object) which utilize a mold material formulation as described herein.

According to some embodiments of this aspect of the invention, the additive manufacturing is of an object (e.g., a three-dimensional object) which comprises, or consists of, a sintered material as described herein.

According to some embodiments of the present invention, the additive manufacturing is or comprises a mold-casting process, as described herein.

The general method involves:
a) printing a first mold to define one layer of the object;
b) filling the first mold with a cast material formulation thereby forming a first layer of the object;
c) printing a second mold on top of the first layer to define a second layer; and
d) filling the second mold, over the first layer, with a cast material formulation, to form a second layer.

The process continues with alternate mold printing and casting until a molded layered object is formed.

Herein, a “paste” and a “cast material” are used interchangeably to describe the material the fills the mold layer(s).

In some embodiments, a sealing hood is provided at the printing location and initially opens to a first position allowing paste to be applied within the mold and then closes to provide an airtight seal around the mold and the paste applied within the mold. Then a vacuum source evacuates air from the sealing hood in its closed position, and thus applies a vacuum to the paste. The vacuum removes liquids from the paste, and thus hardens the paste.

Removal of the mold material is then effected to provide either a final object made of a hardened cast material or to provide a green body which is then subjected to further post-processing steps. For example, the green body can be subjected to further hardening of the cast material. Alternatively, removal of the binder, if present within the cast material, to thereby obtain the brown body, is performed. Sintering can be applied, in cases where the cast material comprises a sinterable material, to thereby provide a final object which contains or consists of a sintered material.

The final object can be a product per se or a product part.

An additional method is provided for dealing with irregular shapes when sintering is required. A support component is printed, having a shape complementary to the product or part, in an associated process, also using additive manufacturing methodology as defined herein. The support component supports the object during sintering by fitting the object into the complementary shape prior to placing in the furnace for sintering. Exemplary support materials and method utilizing same are described in WO 2020/129049, which is incorporated by reference as if fully set forth herein.

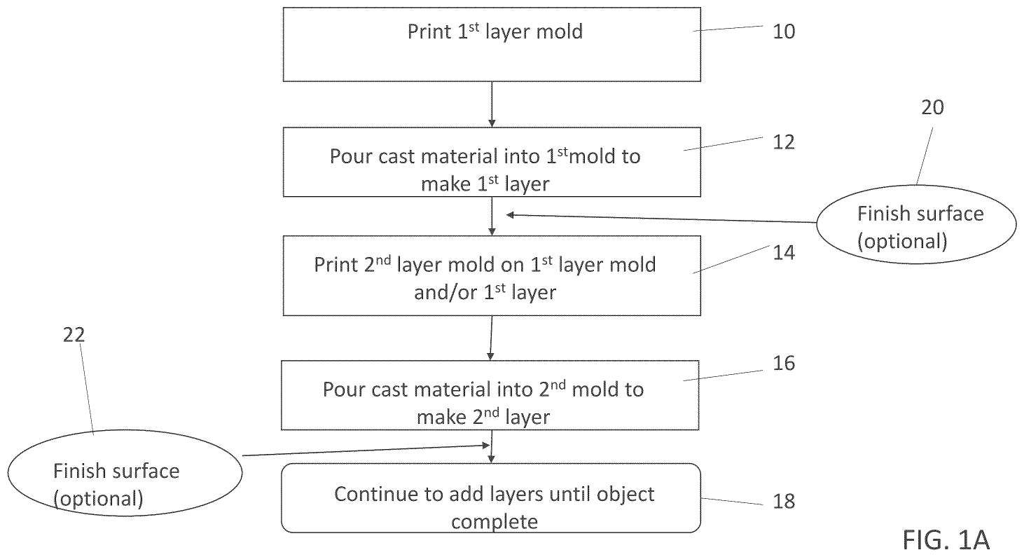

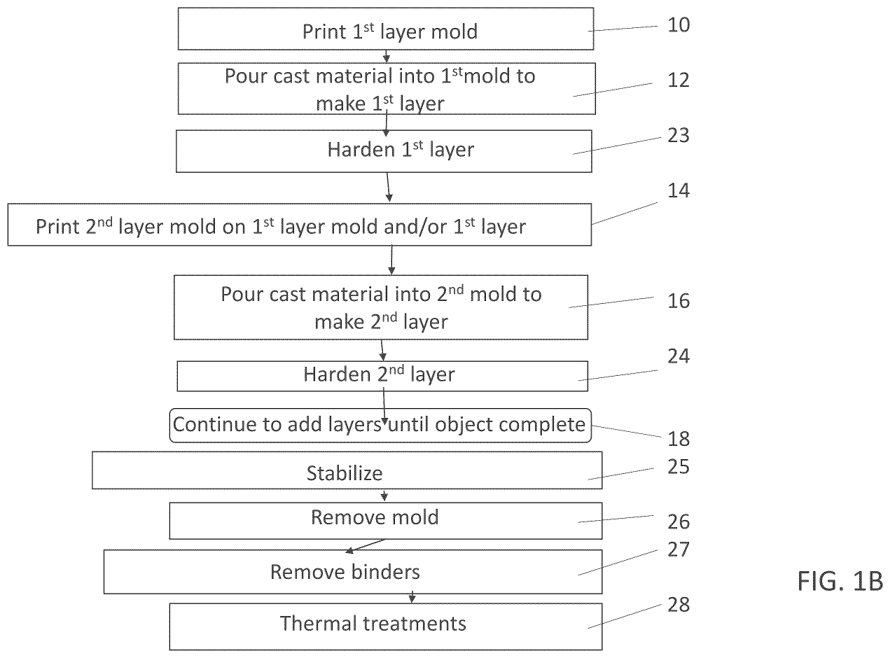

FIG. 1A is a simplified flow chart showing an exemplary method of manufacturing a molded layered object according to some of the present embodiments. A first box 10 indicates printing a first mold to define one layer of the object, by, for example, dispensing a mold material formulation as described herein in a configured pattern according to the final shape of the object. The Box 12 indicates pouring a cast material formulation (e.g., as described herein) to fill the mold printed in box 10. The cast material may then form a first layer of the eventual molded layered object.

In box 14 a second layer mold is then printed on the first layer and/or on the first molding layer. In some cases the second layer is smaller than the first layer in at least one dimension, so that the second layer mold is deposited on the cast part of the first layer. As will be discussed in greater detail below, the cast layer may be hardened to support the printing, or printing of the second layer mold may wait until the first layer is sufficiently dry, or hardened to support the second layer mold.

In box 16 a cast material formulation is poured into the second layer mold to form the second layer of the object. As shown in box 18, the procedure is repeated as often as necessary to form a molded layered object with the requisite number of layers. It will be appreciated that different layers may be of different thicknesses. Different layers may form using same or different cast material formulations. Different cast material formulations can differ from one another by, for example, the type and/or particle size and particle size distribution of a sinterable material if present, the type of one or more of the binder materials if present, and/or the type and/or amount of an organic solvent (e.g., as described herein), if present.

After pouring, the new surfaces of the cast layers may optionally be finished or polished with finishing tools as shown in 20 and 22.

The molds are printed using mold material formulation as described herein in any of the respective embodiments. The molds are printed using a 3D printing technique. Any standard 3D printing technique, such as fused deposition modeling (FDM) or Inkjet printing (e.g. 3D inkjet printing), may be used to print the mold. In some embodiments, the molds are printed using 3D inkjet printing.

In some embodiments the tendency may be for the process to heat up beyond a desired temperature. Thus cooling processes may be used, such as using air flow.

Hardening of the cast material formulation may include evaporation or activation reactions including energy curing, say thermosetting, or UV curing and the like, depending on the chemical composition of the cast material formulation. IR, microwave or UV irradiation may be used as well as blowing with warm/hot air.

The layered object obtained by the AM method may then be heated to melt the mold material, or may be immersed in a solvent to dissolve the mold material, and then may be immersed in a solvent to leaching out part of the additives and may be heated to a higher temperature to remove the binders if present and also may be further sintered if sinterable materials are used and/or may be subjected to other common thermal processes such as HIP (Hot Isotropic Pressure).

The described process may provide a way to make molded objects containing sinterable materials.

In some embodiments, the mold and cast materials are selected such that the cast material is immiscible in the mold material and vice versa. In exemplary embodiments, the cast material formulation is an aqueous-based formulation, while the mold material is a hydrophobic material, as described herein.

In some of any of the embodiments described herein, the cast material formulation has rheological properties to able to flow and fill the mold from one side and to properly lay to the deposited mold materials at the mold interface surface.

A mold design approach may allow a decrease in the load of the mold material over the slip cast material. Engineering of the design process may ensure that the weight of the deposited mold materials is divided over an area as large as possible so as to support the structure.

In embodiments, the dispensed mold material may have a viscosity which is higher than the viscosity of the cast material, so that the mold remains intact when the cast material is poured in. The cast material may have good wetting to properly fill the mold.

In embodiments, the cast material formulation may have low viscosity at room temperature and good wetting ability of the mold material. The cast material formulation may be capable of being hardened after deposition by exposure to a curing condition, as described herein.

Using formation of a layered object as described herein, in AM process, a product may be built with strong layered bonding without mechanical or chemical defects.

Casting or pouring may be carried out at an elevated temperature, with tight control of materials to provide the mechanical properties necessary. Pouring may use a liquid dispensing system that consists of a dispensing control unit. The quantity of filling material may be set according to Sub Mold parameters such as volume, overflow factor, etc. Then the cast material may be leveled by mechanical means such as a squeegee or blade or under its own self leveling property with an optional vibrating procedure.

Later on, the Sub Molds, that is the molds of the individual layers, may be removed by exposing the assembly to a higher temperature, and/or using a chemical dissolving process say with an acid and/or by immersion in solvent to dissolve the mold material or other processes. Suitable temperatures in the case of a mold material formulation according to the present embodiments may be in the range of 50-100° C., preferably in a range of 50-80, or 50-70, ° C.

In cases where the cast material formulation comprises a sinetrable material and a binder, the debinding and sintering stage may involve increasing the temperature to allow debinding and sintering of the active part of the cast material, and typical temperatures for de-binding and sintering are in the range of 200° C.-3000° C., depending on the exact material and required mechanical properties of the final product.

According to a proposed process according to the present embodiments, a paste cast material is casted under shear force and under controlled temperature. The paste cast material in this embodiment may be deposited over the previous layer of cast material that was cast at high viscosity, hardness and may be at a lower temperature.

Drying, debinding and sintering may be carried out in ovens, which may be integrated in a single device or may be provided separately.

A process according to FIG. 1A is now considered in greater detail.

The process may use a cast material formulation and a mold material formulation. The mold material formulation is as described herein in any of the respective embodiments. The mold material formulation may be applied by any controlled additive manufacturing tool such as FDM or Inkjet technology as discussed above.

Referring now to FIG. 1B, the process comprises as in box 10, building of the mold, in which 3D printing uses a mold material formulation according to the present embodiments.

A tray is placed in position and the first layer mold sub part is built on the tray.

The mold is then filled 12 with a cast material formulation (e.g., a paste as described herein). The cast material may be poured, or may in embodiments be injected, under a high shear force into the mold to ensure intimate contact with the mold walls, thereby to ensure proper and complete filling of the mold. The mold itself may be mechanically strong enough to cope with the injection forces.

The now formed (n−1) layer provides a base for the next, the n^{th}, layer.

Solidifying or hardening 23 the cast material slurry or paste may be needed to render the layer capable of bearing the load of the subsequent layer of mold material. In other cases the viscosity of the layer already formed may be sufficient. Solidifying or hardening of the cast material formulation may be achieved by using varying means, depending on the components of the formulation. The following lists exemplary means:
Subjecting the cast material formulation to a curing condition at which polymerization and/or cross linking of a binder occurs;
Subjecting the cast material formulation to a temperature at which at least one of its components solidifies; and/or
Evaporating at least a portion of the liquid carrier (e.g., an aqueous solution or an organic solvent) to thereby harden the cast material formulation.

The process then continues by printing the next mold layer 14.

The second mold layer may be printed on the surface of the previously cast paste material and may also be built over mold material from the previous layer.

The next stage is to fill the second mold layer, in a similar manner to that carried out for the first layer—16. Solidifying 24 may also be provided as needed.

For each additional layer needed in the product, the stages of hardening, printing and filling are repeated—18.

The hardened casting material in the shape of the final object, is now embedded in the Sub Molds.

The final object may now be stabilized 25. While stopping the shear forces, the slurry or paste may start hardening, thus developing green strength to the cast material. Green strength is the mechanical strength which may be imparted to a compacted powder in order for the powder to withstand mechanical operations to which it is subjected before sintering, without damaging its fine details and sharp edges.

The mold material may then be removed—26. Removal may involve heating the green body and mold up to the melting point of the mold so that the mold material liquidizes and can be collected for re-use. Alternatively the mold may be removed by chemical dissolution in a suitable organic solvent that dissolves the mold material, such as described herein.

In all mold and sub mold parts production a sink for collecting melted mold material for reuse may be provided.

According to the present embodiments, removal of the mold material comprises immersing the green body in a solvent bath, heating to a temperature around the melting point of the mold material, so as to initiate disintegration of the mold material, and optionally further at higher temperature, so as to promote dissolution of the mold material in the solvent. The solvent is preferably an aliphatic organic solvent as described herein in any of the respective embodiments.

Once the mold has been removed and a green body as defined herein in obtained then sacrificial materials (e.g., binder materials) of the cast material, if present, are removed −27, for example by decomposing the sacrificial materials, by controllably heating to the optimal temp.

After the sacrificial materials are removed, the active part of the cast material may be fused into solid form (e.g., sintered). A thermal treatment—box 27—such as sintering, may be applied to obtain the desired final properties for the product. As mentioned above, exemplary temperatures between 400° C. and 1800° C. may be used, and in particular temperatures exceeding 500° C.

A variation of the above method is based on applying a vacuum to facilitate hardening of the part during the manufacturing process.

According to some embodiments, the process involves firstly forming a layer, for example by printing a mold layer and then filling the mold with a cast material (e.g., a paste). The building part layer may then be heated with hot air, say for 30 seconds, at 45° C.

Following heating, the layer is capped with a vacuum hood that forms a vacuum seal around the layer. The seal may generally extend around the rest of the part insofar as it has been manufactured. The volume within the hood is then pumped to provide a suitable level of vacuum, for example at a pressure level of around 1 mbar and the low pressure is then held for a predetermined amount of time, say 30 seconds.

Finally, the volume is vented to atmospheric pressure.

The first, heating, stage may excite the part surface to increase the energy of the liquid molecules, generally water or various solvents.

In some embodiments, cycles of heating followed by vacuum may be used. In further embodiments, the venting to release the vacuum may be carried out using warmed air.

A possible apparatus for carrying out the above method for hardening a cast material (e.g., a paste) within walls of a mold, may comprise a sealing hood that opens to a first position allowing cast material formulation to be applied within the mold and then closes to provide an airtight seal around the mold and the cast material formulation applied within the mold. Then a vacuum source evacuates air from the sealing hood in its closed position to apply a vacuum to the cast material formulation. The vacuum removes water or other liquids from the cast material formulation, and thus provides a hardened, or at least partially hardened case material.

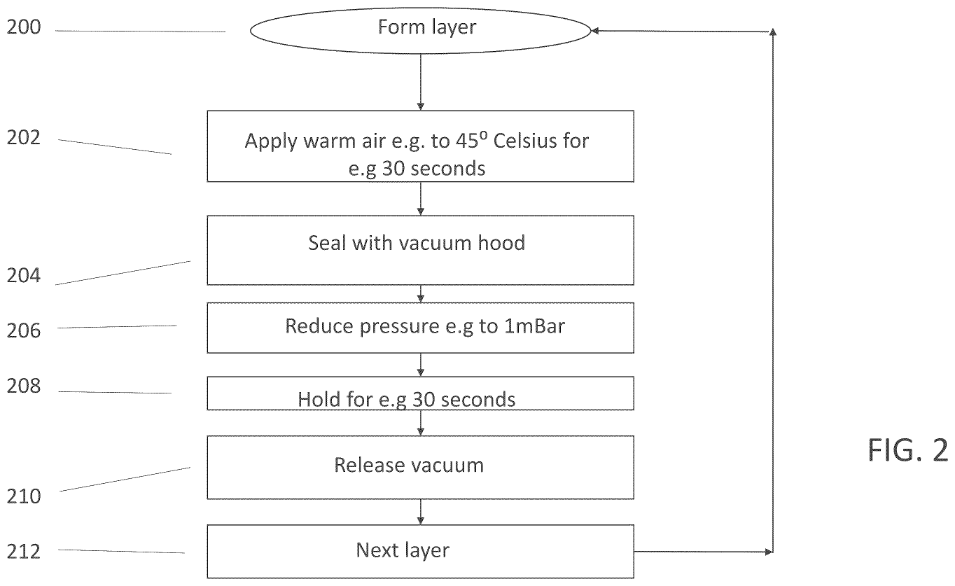

FIG. 2 is a simplified flow chart showing another exemplary method of manufacturing a molded layered object. A first layer is formed using a paste cast material formulation—box 200. As will be explained below, in embodiments a mold may be printed enclosing an area which is to be filled by a cast material formulation is a form of a paste and the paste is spread within the printed mold to form the layer. Other methods to form a layer from a paste may be used.

As shown in box 202 there is an optional stage of heating the layer. For example, warm air may be blown onto the newly formed layer. Heating is optional because hardening using a vacuum works even without prior heating of the paste. However the use of heating may improve evaporation rate efficiency. Heating may be limited to temperatures that are below the mold melting temperature, say kept at 15-20° Celsius below the melting temperature. According to the present embodiments, the melting point of the mold material is in a range of 50-70° C., and the heating is limited to 40-50° C. If warm air is used for heating then the warm air is kept at least slightly below the melting temperature of the mold material.

Subsequently the newly formed layer may be sealed into an airtight chamber, for example by closing a vacuum hood over the emerging structure of the part or product being formed—box 204.

A vacuum may then be applied to the layer for a preset amount of time to harden the paste. The vacuum needs to be enough to cause liquid within the paste to boil at the current temperature.

The vacuum may be held for a preset delay chosen to be effective, for example 30 seconds—as per box 208. The vacuum may be released and the vacuum hood removed, as per box 210.

The process may be continued 212 with the printing of successive additional layers, each over a preceding layer. For each layer a mold is printed and filled with a cast material (e.g., paste) formulation. The layer is sealed. The vacuum is applied, held for the required time and then released, and eventually a molded layered product or part may result.

As shown in box 20 in FIG. 1A, smoothing (finishing the surface) may be carried out of the layer currently being formed. Smoothing may be carried out before hardening by running a spatula, blade or the like over the surface. Alternatively or additionally, smoothing may be carried out after hardening, say by cutting away any unwanted protrusions using a planning process. As a further alternative, smoothing may be carried out before and planning after hardening. In either case a smooth surface may be provided as the base for printing the mold for the following layer. This is to ensure that the next layer is produced on a finished surface of the preceding layer.

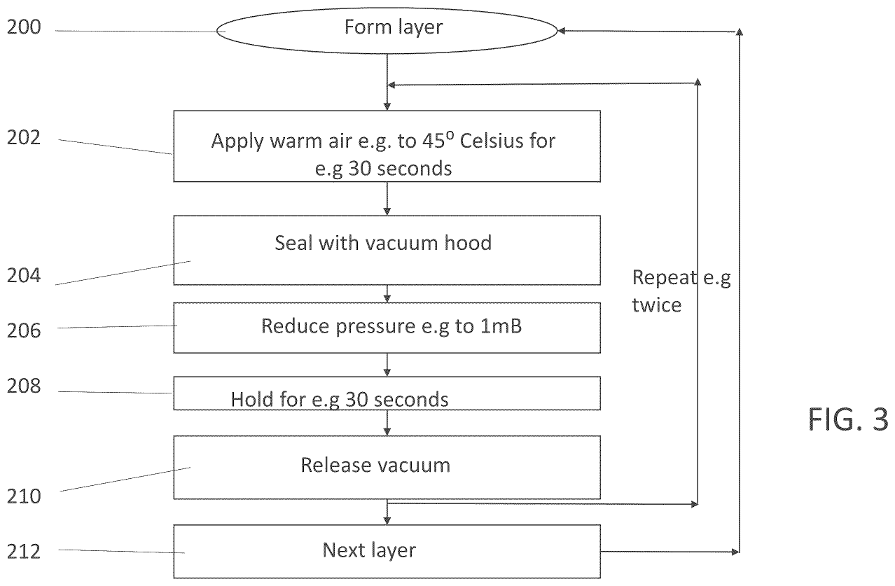

Reference is now made to FIG. 3, which shows a variation of the embodiment shown in FIG. 2. Parts that are the same as in FIG. 2 are given the same reference numerals and are not discussed again except as needed for understanding the present variation. As shown in FIG. 3, sealing 204, applying a vacuum by reducing pressure 206, holding for a preset time 208, and releasing the vacuum, are repeated for individual layers, so that the vacuum may be applied twice, three times or more for individual layers.

Heating 202 may also be applied twice, three times or more. In an embodiment, the vacuum hood remains over the layer throughout the cycle. The layer is initially heated, then the vacuum hood is applied. The vacuum is applied and held for the requisite time and then released by allowing warmed air into the vacuum hood. The vacuum is then reapplied by evacuating the hood of the warmed air.

Planning may be carried out with each layer after hardening.

In an embodiment the hardness of the layer is tested after one cycle. If the hardness is below a predetermined level then a further cycle is carried out.

In more detail, after printing the mold, applying the cast material formulation and filling the mold with the squeegee, the cast material (e.g., a paste) is wet. In the next process, the air-drying process, part of the liquids in the cast material (e.g., a paste) are removed, however, the layer is not hard enough and cannot survive the planning process.

The vacuum stage dries and removes most the liquids trapped in the object during build up.

After applying the vacuum process, the layer may be hard enough to withstand the cutting (planning) process, and there is a correlation between hardness and strength—and a hard layer means a strong green strength for the part.

There are several methods and scales to measure hardness, and common methods used in engineering and metallurgy fields are Indentation hardness measures. Common indentation hardness scales are Rockwell, Vickers, Shore, and Brinell, amongst others, and in an embodiment, a Shore A hardness test is carried out using a durometer. Layers that achieved a level at or above 90 Shore hardness could be effectively planed. Layers whose hardness was below 90 Shore A could be damaged in the planning process. Thus in an embodiment, if a cycle of vacuum and heat does not harden the layer to 90 Shore A hardness, then the cycle is repeated. If the required hardness is reached then no further cycles are used.

In a further embodiment, the vacuum hood may be placed initially over the layer as soon as it is formed, and the initial heating may also be carried out by inserting warmed air into the hood. The subsequent vacuum may in some embodiments involve warmed air at suitably low pressure. Other methods of heating include using infra-red radiation. Radiation heating may be applied during the vacuum.

It is noted that successive layers of the object may be made of the same materials, facilitating fusion of the layers. Alternatively, different cast material formulations may be used in different layers, say when the final product requires different mechanical properties in different places.

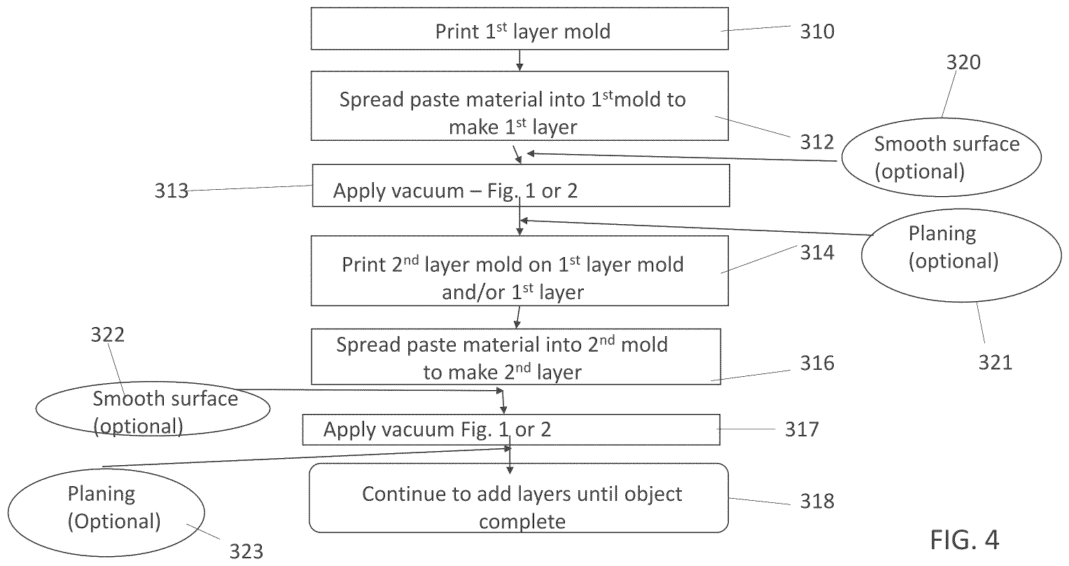

Reference is now made to FIG. 4, which is a simplified flow chart showing an exemplary method of manufacturing a molded layered object according to the present embodiments. A first box 310 indicates printing a first mold to define one layer of the object, using a mold material formulation according to the present embodiments. The mold may be printed using known Additive Manufacturing technology (e.g., 3D inkjet printing). Box 312 indicates spreading a cast material formulation to fill the mold printed in box 310. A squeegee may spread the cast material formulation across the mold.

The cast material formulation, optionally in a form of paste, may then form a first layer of the eventual molded layered object but is currently soft, containing an amount of a liquid (e.g., an aqueous solution or an organic solvent), and the procedure outlined in FIG. 2 or 3 may be applied to harden the layer—box 313.

In box 314 a second layer mold is then printed on the first layer and/or on the first molding layer. In some cases the second layer is smaller than the first layer in at least one dimension, so that the second layer mold is deposited on the cast material portion of the first layer. The cast material layer has now been hardened to support the printing of the second layer mold.

In box 316 more cast material formulation is poured into the second layer mold to form the second layer of the object. As shown in box 317 the hardening procedure of FIG. 2 or 3 is carried out. As shown in box 318, further layers are added to form a molded layered product or part with the requisite number of layers.

After pouring and optionally before or after hardening or both, the new surfaces of the cast material layers may optionally be smoothed, finished, planed and/or polished with finishing tools as shown in 320, 321, 322 and 323.

In some embodiments, the final object may then be heated to melt the mold material, or may be immersed in solvent to dissolve the mold material, and then may be immersed in solvent to leaching out part of the additives and/or may be heated to a higher temperature to remove the binders and also may be further sintered to fuse the powder and may even be subjected to other common thermal processes such as HIP (Hot Isotropic Pressure), as described herein.

The process of FIG. 4 is now considered in greater detail.

A paste cast material formulation may be dried and hardened at a temperature higher than the freeze temperature and lower than the mold material melting point. To ensure the stability of the first layer of cast material the cast material formulation is designed to possess rheological properties that cause the still non-flowing material to be hardened and when needed, to include appropriate shear thinning and thixotropy, so that the viscosity may or may not vary.

Referring again to FIG. 4, and the process comprises as in box 310, building of the mold, in which 3D printing uses a mold material formulation according to the present embodiments, to form the mold parts.

The mold is then filled 312 with a cast material formulation, e.g., in a form of a paste. The cast material formulation may be poured, or may in embodiments be injected, under a high shear force into the mold to ensure intimate contact with the mold walls, thereby to ensure proper and complete filling of the mold. The mold itself is mechanically strong enough to cope with the injection forces.

The now formed (n−1) layer provides a base for the next, the n^{th}, layer.

Hardening the paste as shown in FIGS. 2 and 3, may render the layer capable of bearing the load of the subsequent layer of mold material.

The process then continues by printing the next mold layer 314.

The second mold layer may be printed on the surface of the previous layer and may even be built over mold material from the previous layer.

The next stage is to fill the second mold layer, in a similar manner to that carried out for the first layer—316. Hardening 317 may also be provided separately for the second layer.

For each additional layer needed in the object, the stages of printing, filling, optionally heating, and hardening are repeated—318.

The hardened cast material in the shape of the final object, is now embedded within the Sub Molds that is the mold produced for each layer.

The final object may optionally be stabilized once all the layers have been manufactured. While stopping the shear forces, the cast material formulation may start hardening, thus developing green strength to the cast material.

The mold material may then be removed. Removal may involve heating the product and mold up to the melting point of the mold so that the mold material liquidizes and can be collected for re-use. Alternatively, the mold may be removed by chemical dissolution as described herein.

According to some embodiments, the mold is removed as described hereinabove.

In general the hardening process of FIGS. 2 and 3 has removed the liquid carrier (the aqueous solution) from the cast material. Other materials such as binder materials if present may now be removed by controllably heating to an optimal temperature. The mold has already been removed so that heating is no longer limited by the mold melting point.

After the sacrificial materials are removed, the powder may be fused into solid form. A thermal treatment such as sintering, may be applied to obtain the desired final properties for the product. Exemplary temperatures as described herein may be used.

Cast Material Formulation:

In general, any cast material formulation commonly used in mold casting methodologies, can be used in a process as described herein.

In some embodiments, cast material formulations as described in WO 2018/203331, WO 2020/044336, WO 2020/225591 and PCT/IL2021/051349 are used.

In some embodiments, a cast material formulation as described in WO 2020/225591 is used in combination a mold material formulation according to the present embodiments.

In exemplary embodiments, the cast material formulation comprises a powder of a sinterable material and an aqueous solution (also referred to herein as an aqueous carrier). In some embodiments, the formulation comprises a powder of the sinterable material dispersed in an aqueous solution.

In some of any of the embodiments described herein, the aqueous solution comprises water and a water-miscible organic solvent. In some embodiments, the water-miscible organic solvent is characterized by an evaporation rate that ranges from 0.3 to 0.8, or from about 0.3 to about 0.65.

An evaporation rate, as used herein, refers to n-butyl acetate as the reference material.

According to some embodiments of the present invention, the sinterable paste formulation comprises a power of a sinterable material, a binder, and an aqueous solution, as described herein in any of the respective embodiments.

According to some of any of the embodiments described herein, an amount of the powder is at least 85% by weight of the total weight of the formulation. According to some of any of the embodiments described herein, an amount of the powder is at least 87%, or 88%, or 89%, or at least 90%, at least 91% or at least 92%, or at least 95%, by weight, of the total weight of the formulation. According to some of any of the embodiments described herein, an amount of the powder ranges from about 85 to about 95, or from about 88 to about 92, % by weight of the total weight of the formulation, including any intermediate values and subranges therebetween.

According to some of any of the embodiments described herein, the aqueous solution comprises water and a water-miscible organic solvent.

According to some of any of the embodiments described herein, the organic solvent has an evaporation rate in a range of from 0.3 to 0.8, or from 0.3 to 0.7, or from 0.4 to 0.8, or from 0.4 to 0.7, or from 0.5 to 0.7, on an n-butyl acetate scale.

According to some of any of the embodiments described herein, a total amount of the aqueous solution (e.g., of the water and the organic solvent) ranges from 3 to 10, or from 5 to 109, or from 6 to 10, or from 7 to 10, or from 6 to 9, or from 7 to 9, % by weight of the total weight of the formulation, including any intermediate values and subranges therebetween.

According to some of any of the embodiments described herein, an amount of the water-miscible organic solvent in the aqueous solution ranges from 20 to 80, or from 20 to 60, or from to 40, % by weight (weight percent) of the total weight of the aqueous solution.

According to some of any of the embodiments described herein, the water-miscible organic solvent and the binder are selected such that the binder is dissolvable and/or dispersible in the organic solvent or in the aqueous solution containing same.

By “dissolvable or dispersible” it is meant that no more than 30%, or no more than 20%, or no more than 10%, by weight of the binder, precipitate when mixed with the aqueous solution or the organic solvent.

According to some of any of the embodiments described herein, the water-miscible organic solvent and the binder are selected as chemically inert to one another, that is, the organic solvent and the binder do not react chemically with one another when in contact, for example, when contacted with one another at room temperature and/or at conditions used in a mold-cast process as described herein (prior to debinding).

According to some of any of the embodiments described herein, the organic solvent is an alkylene glycol, for example, an alkylene glycol having the formula:

RaO—[(CR′R″)_{z}—O]_{y}-Rb

with Ra, Rb, R′ and R″ being each independently hydrogen, alkyl, cycloalkyl, or aryl, and with z being an integer of from 1 to 10, preferably, 2-6, more preferably 2 or 3, and y being an integer of 1 or more. Preferably R′ and R″ are both hydrogen. Preferably, one or both of Ra and Rb is an alkyl. When z is 2 and y is 1, this group is an ethylene glycol. When z is 3 and y is 1, this group is a propylene glycol.

According to exemplary embodiments, the organic solvent is a propylene glycol, and in some embodiments it is propylene glycol methyl ether.

Other water-miscible organic solvents having an evaporation rate as defined herein are contemplated.

According to some of any of the embodiments described herein, an amount of the binder is no more than 10%, or no more than 5%, or no more than 3%, or no more than 2%, by weight of the total weight of the formulation.

In some embodiments, an amount of the binder ranges from 0.5 to 2, or from 0.8 to 2, % by weight of the total weight of the formulation, including any intermediate values and subranges therebetween.

According to some of any of the embodiments described herein, the binder is thermolizable at a temperature lower by at least 100° C. than a sintering temperature of the sinterable material, so as to assure complete thermolization of the binder during the debinding stage and/or to assure that no binder remains when the brown body is subjected to sintering.

According to some of any of the embodiments described herein, the binder remains intact when subjected to a condition under which the mold material is removed. For example, the binder is non-dissolvable when contacted with an organic solvent that dissolves the mold material and/or at a melting temperature of the mold material.

According to some of any of the embodiments described herein, a volume shrinkage of the binder when subjected to reduced pressure of about 5 mbars is less than 1%.

According to some of any of the embodiments described herein, the binder has a Tg of at least 30° C., or of at least 40° C.

According to some of any of the embodiments described herein, the binder is characterized by a film forming temperature (TMF) of at least 0° C., or at least 5° C. or of at least 10° C. In some embodiments the TMF is in a range of from 0 to 10° C. In some embodiments, the TMF does not exceed the temperature at which the aqueous solution (aqueous carrier) evaporated under reduced pressure.

In some of any of the embodiments described herein, the binder is or comprises a (meth)acrylic polymer, that is an acrylic and/or methacrylic polymer or co-polymer. An acrylic copolymer can be, for example, a co-polymer comprising acrylic/methacrylic backbone units and aromatic backbone units such as styrene backbone units.

The powder of a sinterable material may include a powder of one or more of a metal, a ceramic and/or a glass. In some embodiments, the sinterable materials are sinterable at a temperature of at least 500° C., or at least 800° C., or at least 1000° C., so as to assure complete thermolization of the binder(s) before sintering.

By “sintering” it is meant causing a powder to from a coherent mass without melting it.

Exemplary sinterable glass materials include, but are not limited to, soda-lime-silica glasses, sodium borosilicate glasses, fused silica, and alumino-silicate glasses.

Exemplary sinterable ceramic materials include, but are not limited to, metal oxides such as titania, silica, zirconia, and alumina.

Exemplary sinterable metal materials include, but are not limited to, gold, platinum, copper, silver, zinc, aluminum, antimony, barium, beryllium, bismuth, boron, cadmium, calcium, cerium, cesium, chromium, cobalt, erbium, europium, gadolinium, gallium, germanium, hafnium, holmium, indium, iron, lanthanum, lead, lutetium, lithium, magnesium, manganese, molybdenum, neodymium, nickel, niobium, osmium, palladium, potassium, praseodymium, rhenium, rhodium, rubidium, ruthenium, samarium, scandium, silicon, sodium, strontium, tantalum, tellurium, terbium, thulium, tin, titanium, tungsten, vanadium, yttrium, ytterbium, and zirconium, including alloys containing a combination of two or more metals, such as, for example, brass, steel (e.g., stainless steel), and bronze.

In exemplary embodiments, the sinterable material is or comprises a stainless steel powder.

In some of any of the embodiments described herein, the powder has an average particles size which is no more than 50% of the thickness of the layer formed during the AM process as described herein. In exemplary embodiments, the average particles size ranges from 1 to about 100 microns, or from 1 to about 50 microns, or from 1 to about 20 microns, e.g., 5-15, or 5-10 microns, including any intermediate values and subranges therebetween.

In some of any of the embodiments described herein, the powder is characterized by a high particles size distribution (PSD), for example, higher than commonly used for binder jet or laser beam or electron beam additive manufacturing processes. For example d(50): 10 micron, cutoff: 45 microns. Without being bound by any particular theory, it is assumed that high PSD provides higher tapped density and a more dense packaging of the particles in the printed object.

By “binder” it is meant a curable material, which can be cured (hardened) when exposed to heat or other curing energy or to a curing condition such as, for example, pH change. A binder typically comprises a polymerizable material or a polymeric material which can undergo further polymerization (e.g., chain elongation) and/or cross-linking when exposed to a curing condition (e.g., curing energy such as heat) to thereby provide a hardened material.

In some embodiments of the present invention, the binder is a polymeric material that undergoes cross-linking when exposed to a curing condition.

In some of these embodiments, the binder undergoes self cross-linking.

According to the present embodiments, the binder is selected so as to exhibit one or more, preferably two or more, and preferably all, of the following properties:
Low volume shrinkage (e.g., lower than 1%) when subjected to reduced pressure;
Low tendency to form film, e.g., a film forming temperature (TMF) higher than 5° C. or higher than 10° C., or higher than a temperature used when hardening the cast material is performed (e.g., under vacuum).

Tg of at least 30° C. or at least 40° C.;

Thermolizability at a temperature lower than a sintering temperature of the sinterable material, e.g., lower than 1000° C., preferably lower than 600° C., or lower than 500° C., but higher than a melting temperature of the mold material; and

Low viscosity (e.g., a solution-like behavior at least at high shear rates), for example, a viscosity lower than 10000 centipoises at high shear rate, and optionally a higher viscosity at lower shear rate (e.g., a shear-thinning behavior at ambient temperature). In some embodiments, the binder comprises two or more different materials, each providing to the formulation one or more of the above properties. For example, one binder material can feature a high Tg, one binder material can feature low viscosity, one binder material can feature high TMF, etc., such that the selected combination of binder materials and the relative amounts thereof provide the desired properties as defined herein for a binder.

In exemplary embodiments, the binder comprises two binder materials, also referred to herein as “Binder A” and “Binder B”. In some of these embodiments, Binder A is characterized as a Newtonian fluid and features a Tg higher than 30° C. or higher than 40° C.

In some of these embodiments, Binder B is characterized by a shear-thinning behavior and functions also as a rheology modifier.

In some of any of the embodiments described herein, Binder A and/or B are selected so as to impart to the cast material properties such as stiffness, uniformity, resistance to crack formation during the hardening step and subsequent steps if performed, resistance to solvents used to remove the mold material.

In exemplary embodiments, a weight ratio of the binder materials ranges from 1:3 to 3:1 Binder A:Binder B, including any intermediate values and subranges therebetween.

In some of any of the embodiments described herein, one or more of the binder materials is, or each independently is, a (meth)acrylic polymer, for example, a self cross-linking poly-(meth)acrylic polymer or a styrene-acrylic copolymer.

In some of any of the embodiments described herein, one or more of the binder materials is pre-dispersed in an aqueous solution, as an emulsion. In some of these embodiments, the emulsion comprises 40-60% by weight of the polymeric binder material.

Exemplary materials suitable for use as Binder A include, but are not limited to, those included is the emulsions marketed under the trade names Joncryl® 8224, Joncryl® 2178-E, Joncryl® 537-E, Joncryl® 8211, Joncryl® 617, Joncryl® 652, Joncryl® 646, Joncryl® 142E, Joncryl® 1685, Alberdingk® AC 2523.

An exemplary material usable as binder A is the polymeric material included in an emulsion marketed under the trade name Joncryl® 8224.

Exemplary materials suitable for use as Binder B include, but are not limited to, those included is the emulsions marketed under the trade names Joncryl® 661, Rheovis AS 1125, Rheovis AS 1130, Rheovis HS 1303 EB, Rheovis PU 1291, Carbomer 940; and Carboxy Methyl Cellulose (CMC).

An exemplary material usable as binder B is Joncryl® 661.

Exemplary materials suitable for use as a dispersant (a dispersing agent) include emulsifying agents, but are not limited to, Sodium dodecylbenzensulofonate, sodium lauryl sulfate, Trisodium citrate, Stearic acid, and Citric acid, and those marketed under the trade names Dispex Ultra PX 4483, Dispex Ultra PX 4484, Dispex Ultra PX 4275, Dsipex Ultra PX 4575, DISPERBYK 180, DISPERBYK 192, and DISPERBYK 2060.

An exemplary dispersant is Sodium dodecylbenzenesulfonate.

In an exemplary embodiment, a solution or dispersion of a dispersing agent in an aqueous carrier (e.g., water) is used. In an exemplary embodiment a solution containing 5% by weight Sodium dodecylbenzensulofonate and 95% by weight water is used as a dispersing agent.

Exemplary materials suitable as an anti-foaming agent include materials that may act also as plasticizers, and which provide a desired surface tension to the formulation, such as, but not limited to, those of the BYK family, for example, those marketed under the trade names BYK 024, FoamStar SI 2210, FoamStar ST 2438, FoamStar SI 2240, Byk 093, Byk 025, Byk 1640, Byk 3455, BYK 1680, Foamex 810.

Exemplary materials suitable as pH-adjusting agents include those that impart to the formulation a pH value at which the sinterable material is chemically stable (e.g., does not undergo oxidation) and/or the binder is chemical stable (e.g., does not undergo cross-linking and/or further polymerization).

In some of any of the embodiments described herein, the water-miscible organic solvent is characterized by an evaporation rate, as defined herein, of from 0.3 to 0.9, or from 0.3 to 0.8, or from 0.3 to 0.7.

Without being bound by any particular theory, it is assumed that such a relatively low evaporation rate allows using the formulation in a mold-cast AM process as described herein, such that the solvent does not evaporate when the formulation is dispensed, yet, it evaporates quickly upon dispensing the formulation and subjecting it, for example, to hardening under heat and/or reduced pressure as described herein.

In some of any of the embodiments described herein, the water-miscible organic solvent is such that does not chemically interact with the binder and/or with the mold material. In some embodiments, the organic solvent does not dissolve the mold material.

An exemplary solvent is Propylene Glycol Mono Methyl Ether (PM) CAS No. 107-98-2 (evaporation rate: 0.62). Other exemplary suitable solvents include, but are not limited to, propylene glycol propyl ether (PnP), Dipropylene glycol monomethyl ether (DPM), Propylene Glycol Methyl Ether Acetate (PMA), and Di-acetone Alcohol, and any mixture thereof.

It is to be noted that water-miscible solvents featuring higher evaporation rates can be included in the aqueous solvent, in addition to the organic solvent featuring the evaporation rate as described herein, as long as the total evaporation rate of the aqueous solution does not exceed 0.8, 0.9, or 1.

Herein throughout, the phrases “aqueous solution” and “aqueous carrier” are used interchangeably.

An exemplary formulation according to some embodiments of the present invention comprises:

As a powder of sinterable material: Stainless steel 316L powder, featuring average particles size of 8-10 microns, e.g., d50: 9 microns, was obtained from Huarui China.

As Binder A—Joncryl® 8224—an emulsion containing 45% by weight an acrylic polymer in water.

As Binder B—Joncryl® 661—an emulsion containing about 22-23% by weight an acrylic polymer, about 53-54% by weight water, about 20-21% by weight PM solvent.

As a Dispersant −5% by weight Sodium dodecylbenzensulofonate in water.

As an Anti-foaming agent—BYK 024. As a water-miscible organic solvent—Propylene Glycol Mono Methyl Ether (PM) CAS No. 107-98-2

As a pH adjusting agent—Mono Ethanol Amine.

As water—reverse osmosis DI water.

The formulation of the present embodiments is prepared by mixing the components as described herein, preferably, but not obligatory, at room temperature.

In an exemplary procedure, Binder B, water and a pH adjusting agent are mixed in a closed vessel, optionally in a vibrating mill, for 15 minutes. An anti-foaming agent is thereafter added, and the obtained mixture is vibrated for additional 5 minutes. The organic solvent is then added, the obtained mixture is vibrated for additional 5 minutes and then the dispersant is added and further mixing is performed. Binder A is then added, and the mixture is further mixed. At this stage, the powder of the sinterable material is added and the obtained mixture is mixed for a few hours (e.g., 4 hours). All stages are performed at room temperature.

According to some of any of the embodiments described herein, the formulation comprises one or more additional materials (also referred to herein as additives). Such materials include, for example, a dispersing agent (a dispersant), a pH adjusting agent, an anti-foaming agent, a rheology modifier, a thickener, a surface active agent, and more.

According to some of any of the embodiments described herein, the formulation features an alkaline pH, for example, a pH in a range of at least 8, or from 8 to 10. In some embodiments, the pH is selected such that the binder does not harden when intact.

According to some of any of the embodiments described herein, the formulation exhibits a viscosity of in a range of from 10000 to 50000, or from 10000 to 30000, centipoises, including any intermediate values and subranges therebetween.

According to some of any of the embodiments described herein, the formulation is designed such that is features no shear-thinning behavior under reduced pressure of 5 mBar or 10 mBar.

According to some of any of the embodiments described herein, the formulation comprises:
from 85 to 95% by weight of the powder of the sinterable material, as described herein in any of the respective embodiments;
from 6 to 10% by weight of an aqueous solution which comprises water and the organic solvent, as described herein in any of the respective embodiments; and
from 1 to 2% by weight of the binder, as described herein in any of the respective embodiments.

According to other embodiments, the cast material formulation is waterless or water-free, that is, it is based on an organic vehicle and is devoid of water. Such a formulation is also referred to herein as waterless, or water-free, or organic solvent-based, cast material formulation or sinterable paste formulation In some of any of these embodiments, the cast material formulation is as described in PCT/IL2021/051349, by the present assignee, the contents of which are incorporated by reference as if fully set forth herein.

According to some embodiments of any of the embodiments related to a water-free, organic solvent-based formulation, the sinterable paste formulation comprises a powder of a sinterable material, as described herein in any of the respective embodiments, a binder material, as described herein in any of the respective embodiments, and an organic vehicle, as described herein in any of the respective embodiments (see, for example, Example 3 hereinafter).

According to some of any of the embodiments described herein with regard to an organic solvent-based cast material formulation, an amount of the powder is at least 85% by weight of the total weight of the formulation. According to some of any of the embodiments described herein, an amount of the powder is at least 87%, or 88%, or 89%, or at least 90%, at least 91% or at least 92%, by weight, of the total weight of the formulation. According to some of any of the embodiments described herein, an amount of the powder ranges from about 85 to about 95, or from about 88 to about 92, % by weight of the total weight of the formulation, including any intermediate values and subranges therebetween.

In some embodiments, the organic vehicle comprises at least one organic material that has an evaporation rate of at least 0.1, or at least 0.3, on an n-butyl acetate scale.

In some embodiments, the organic vehicle comprises at least one organic material that is characterized by an evaporation rate that ranges from 0.3 to 0.8, or from about 0.3 to about 0.65.

An evaporation rate, as used herein, refers to n-butyl acetate as the reference material.

According to some of any of the embodiments described herein with regard to an organic solvent-based cast material formulation, the at least one organic material has an evaporation rate in a range of from 0.3 to 0.8, or from 0.3 to 0.7, or from 0.4 to 0.8, or from 0.4 to 0.7, or from 0.5 to 0.7, on an n-butyl acetate scale.

According to some of any of the embodiments described herein with regard to an organic solvent-based cast material formulation, the organic vehicle comprises at least one organic material that has an evaporation rate in a range of from 0.3 to 0.8 on an n-butyl acetate scale, as described herein, and at least one organic material that has an evaporation rate higher than 2 or higher than 3.

According to some of these embodiments, an amount of the organic material that features a low evaporation rate as described herein (e.g., an alkylene glycol) is at least 50%, by weight of the total amount of the organic vehicle.

According to some embodiments, a weight ratio of an organic material with low evaporation rate and an organic material with high evaporation rate ranges from 1:1 to 3:1, or from 1:1 to 2:1, including any intermediate values and subranges therebetween.

According to some embodiments, an amount of the organic material that has an evaporation rate as described herein is at least 50% by weight of the total weight of the organic vehicle.

According to some of any of the embodiments described herein with regard to an organic solvent-based cast material formulation, the organic vehicle comprises an alkylene glycol.

According to some of any of the embodiments described herein with regard to an organic solvent-based cast material formulation, the organic vehicle comprises an alkylene glycol, typically as an organic material that features a low evaporation rate as described herein, for example, an alkylene glycol having the formula:

RaO—[(CR′R″)_{z}—O]_{y}-Rb

with Ra, Rb, R′ and R″ being each independently hydrogen, alkyl, cycloalkyl, or aryl, and with z being an integer of from 1 to 10, preferably, 2-6, more preferably 2 or 3, and y being an integer of 1 or more. Preferably R′ and R″ are both hydrogen. Preferably, one or both of Ra and Rb is an alkyl. When z is 2 and y is 1, this group is an ethylene glycol. When z is 3 and y is 1, this group is a propylene glycol.

According to exemplary embodiments, the organic vehicle comprises a propylene glycol, and in some embodiments it comprises a propylene glycol methyl ether.

Other organic material having an evaporation rate as defined herein are contemplated as included in the organic vehicle.

According to exemplary embodiments, the organic vehicle comprises a mixture of an alkylene glycol as described herein and a ketone-type material, as an organic material that has high evaporation rate, for example, an acetone type material of the formula:

Rx-C(═)-Ry

Wherein Rx and Ry are each independently an alkyl, preferably a lower alkyl of 1-6, or 1-4, carbon atoms on length.

In some embodiments, one of Rx and Ry is methyl and the other is ethyl, propyl, or butyl.

According to some of any of the embodiments described herein with regard to an organic solvent-based cast material formulation, the organic vehicle comprises an alkylene glycol.

According to some of any of the embodiments described herein with regard to an organic solvent-based cast material formulation, the organic vehicle comprises a mixture of an alkylene glycol and a ketone, as described herein.

According to some of any of the embodiments described herein with regard to an organic solvent-based cast material formulation, a total amount of the organic vehicle ranges from 3 to 10, or from 4 to 10, % by weight of the total weight of the formulation.

According to some of any of the embodiments described herein with regard to an organic solvent-based cast material formulation, a total amount of the organic vehicle ranges from 4 to 15, or from 4 to 10, or from 4 to 8, % by weight of the total weight of the formulation, including any intermediate values and subranges therebetween.

According to some of any of the embodiments described herein with regard to an organic solvent-based cast material formulation, the organic vehicle and the binder material are selected such that the binder material is dissolvable and/or dispersible in the organic vehicle.

By “dissolvable or dispersible” it is meant that no more than 30%, or no more than 20%, or no more than 10%, by weight of the binder material, precipitate when mixed with the organic vehicle.

According to some of any of the embodiments described herein with regard to an organic solvent-based cast material formulation, the organic vehicle and the binder material are selected as chemically inert to one another, that is, the organic vehicle and the binder material do not react chemically react with one another when in contact, for example, when contacted with one another at room temperature and/or at conditions used in a mold-cast process as described herein (prior to debinding).

According to some of any of the embodiments described herein with regard to an organic solvent-based cast material formulation, the organic vehicle and the binder material are selected capable of physically interacting with one another.

According to some of any of the embodiments described herein with regard to an organic solvent-based cast material formulation, an amount of the binder material is no more than 10%, or no more than 5%, or no more than 3%, or no more than 2%, by weight of the total weight of the formulation.

In some embodiments, an amount of the binder material ranges from 0.5 to 2, or from 0.8 to 2, % by weight of the total weight of the formulation, including any intermediate values and subranges therebetween.

According to some of any of the embodiments described herein with regard to an organic solvent-based cast material formulation, the binder material is not in a form of an emulsion.

According to some of any of the embodiments described herein with regard to an organic solvent-based cast material formulation, the binder material is devoid of water.

According to some of any of the embodiments described herein with regard to an organic solvent-based cast material formulation, the binder material is thermolizable at a temperature lower by at least 100° C. than a sintering temperature of the sinterable material, so as to assure complete thermolization of the binder material during the debinding stage and/or to assure that no binder material remains when the brown body is subjected to sintering.

According to some of any of the embodiments described herein with regard to an organic solvent-based cast material formulation, the binder material remains intact when subjected to a condition under which the mold material is removed. For example, the binder material is non-dissolvable when contacted with an organic solvent that dissolves the mold material and/or at a melting temperature of the mold material.

According to some of any of the embodiments described herein with regard to an organic solvent-based cast material formulation, a volume shrinkage of the binder material when subjected to reduced pressure of about 5 mbars is less than 1%.

According to some of any of the embodiments described herein with regard to an organic solvent-based cast material formulation, the binder material has an (e.g., average) Tg of at least 25, or at least 30, ° C.

According to some of any of the embodiments described herein with regard to an organic solvent-based cast material formulation, the binder material comprises a mixture of two or more binders, and a Tg of each of these binders ranges from 25 to 150, or from 25 to 100, or from 30 to 150, or from 30 to 100, or from 30 to 80, ° C.

According to some of any of the embodiments described herein with regard to an organic solvent-based cast material formulation, the binder material is characterized by a film forming temperature (TMF) of at least 0° C., or at least 5° C. or of at least 10° C. In some embodiments the TMF is in a range of from 0 to 10° C. In some embodiments, the TMF does not exceed the temperature at which the organic vehicle evaporates under reduced pressure.

Additional features of the binder material, and exemplary suitable binders, are described in the Examples section that follows (see, Example 3).

According to some of any of the embodiments described herein with regard to an organic solvent-based cast material formulation, the binder is or comprises a (meth)acrylic polymer, that is an acrylic and/or methacrylic polymer or co-polymer. An acrylic copolymer can be, for example, a co-polymer comprising acrylic/methacrylic backbone units and aromatic backbone units such as styrene backbone units.

According to some of any of the embodiments described herein with regard to an organic solvent-based cast material formulation, the formulation comprises one or more additional materials (also referred to herein as additives). Such materials include, for example, an antioxidant, a dispersing agent (a dispersant), a pH adjusting agent, an anti-foaming agent, a rheology modifier, a thickener, a surface active agent, and more.

Exemplary such materials are described in the Examples section that follows (see, Example 3).

According to some of any of the embodiments described herein with regard to an organic solvent-based cast material formulation, the formulation exhibits a viscosity of in a range of from 10000 to 200000, centipoises, including any intermediate values and subranges therebetween.

According to some of any of the embodiments described herein with regard to an organic solvent-based cast material formulation, the formulation exhibits a shear-thinning behavior at atmospheric pressure.

According to some of any of the embodiments described herein with regard to an organic solvent-based cast material formulation, the formulation is designed such that is features no shear-thinning behavior under reduced pressure of 5 mBar or 10 mBar.

According to some of any of the embodiments described herein with regard to an organic solvent-based cast material formulation, the formulation comprises:
from 85 to 95% by weight of the powder of the sinterable material, as described herein in any of the respective embodiments;
from 4 to 10% by weight of an organic vehicle, as described herein in any of the respective embodiments; and
from 0.8 to 2% by weight of the binder material, as described herein in any of the respective embodiments.

According to some embodiments of the present invention there is provided a kit comprising a cast material formulation as described herein in any of the respective embodiments and any combination thereof, and a mold material formulation as described herein in any of the respective embodiments. The cast and model formulations are packaged individually within the kit.

According to some of any of the embodiments described herein with regard to an organic solvent-based cast material formulation, the cast material formulation is as described in Example 3 in the Examples section that follows. The cast material formulation is also referred to herein as a sinterable paste formulation.

According to some embodiments of the present invention, there is provided a cast material formulation comprising, or consisting of, the materials/components presented in Example 3 or in Table A.

Kits:

According to some embodiments of the present invention there is provided a kit comprising a mold material formulation as described herein in any of the respective embodiments and any combination thereof, and a cast material formulation as described herein in any of the respective embodiments. The cast and mold formulations are preferably packaged individually within the kit.

According to some embodiments of the present invention there is provided a kit comprising a mold material formulation as described herein in any of the respective embodiments, and instructions to use the formulation in a process as described herein in any of the respective embodiments. In some embodiments, the kit comprises instructions to use the formulation with a cast material formulation as described herein in any of the respective embodiments.

Objects and Products:

According to an aspect of some embodiments of the present invention there is provided a product obtained by a method as described herein in any of the respective embodiments and any combination thereof.

According to an aspect of some embodiments of the present invention there is provided a 3D mold-cast object obtainable by the mold-cast process as described herein in any of the respective embodiments and any combination thereof.

According to an aspect of some embodiments of the present invention there is provided a green body obtainable by the mold-cast process as described herein in any of the respective embodiments and any combination thereof, upon removal of the mold material.

According to an aspect of some embodiments of the present invention there is provided a brown body obtainable by the mold-cast process as described herein in any of the respective embodiments and any combination thereof, upon removal of the mold material and the binder material(s) and any other additives.

According to an aspect of some embodiments of the present invention there is provided a 3D mold-cast object obtainable by the mold-cast process as described herein in any of the respective embodiments and any combination thereof.

According to an aspect of some embodiments of the present invention there is provided an article-of-manufacturing or a part thereof, which comprises the product as described herein.

Exemplary articles-of-manufacturing or parts thereof include, but are not limited to, large articles such as cars, trucks, railway cars, airframes, aircraft engines, marine vessels, sailing ship masts, street lighting poles, railway tracks, oil well casings, hydroelectric turbines, nuclear reactor control rods, windows, doors, mirrors, astronomical instruments, etc. Small articles such as car engines, gears, fasteners, watches, cooking utensils, food containers, bicycle components, packaging, outer shells of consumer electronics, heat sinks for electronic appliances, substrates in high brightness light-emitting diode (LED) lighting, hardware tools, and many other metallic articles.

It is expected that during the life of a patent maturing from this application many relevant molding, 3D printing and casting technologies will be developed and the scopes of the corresponding terms are intended to include all such new technologies a priori.

It is expected that during the life of a patent maturing from this application many relevant sinterable materials, binders, and any of the other materials usable in the present embodiments will be developed and the scope of the corresponding terms is intended to include all such new technologies a priori.

As used herein the term “about” refers to ±10% or ±5%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### Mold Material Formulations

Table 1 below presents exemplary waxes that were used in various tested mold material formulations and Table 2 presents representative properties thereof (as provided by the vendor).

TABLE 1

| No. | Type | Vendor | Tradename | Description |
|---|---|---|---|---|
| A1 | Paraffin wax | Eastman | Foralyn ™ 90 | Glycerol ester of hydrogenated rosin |
| A2 | Paraffin wax | Eastman | Foralyn ™ 110 | Pentaerythritol ester of hydrogenated |
| | | | | rosin (CAS No. 64365-17-9) |
| A3 | Paraffin wax | Koster | Permulgin | Paraffinic and isoparaffinic |
| | | Keunen | 3274 | hydrocarbons with carbon chain lengths |
| | | | | of about C20 and C70 |
| A4 | Paraffin wax | Munzing | Ceretan ® M- | Non micronized, refined, very hard |
| | | | 81 | Montanester wax (Type E) |
| A5 | Paraffin wax | Arakawa | Arkon P90 | Fully hydrogenated hydrocarbon resin |
| A6 | Paraffin Wax | Arakawa | Arkon P100 | Fully hydrogenated hydrocarbon resin |
| A7 | Paraffin wax | DRT | Dercrolyte TS | Polyterpene resin, produced by co- |
| | | | 105 | polymerization of terpene and styrene |
| A8 | Microcrystalline | Sasol Ltd. | Sasolwax ® | Hard Microcrystalline Wax |
| | Paraffin wax | | 3279 | a multi-component blend of saturated |
| | | | | hydrocarbons, containing elevated |
| | | | | content of iso- and cyclo-alkanes |
| A9 | Microcrystalline | Sasol Ltd. | Sasolwax ® | Low molecular weight low viscosity |
| | Paraffin wax | | 5203 | hard and microcrystalline paraffin wax |
| A10 | Parrafin wax | Sasol Ltd. | Sasolwax ® | A blend of saturated hydrocarbons, |
| | | | 5803 | purified by hydrogenation |
| B1 | Vegetable wax | | Caranuba wax | Hard natural wax derived from the |
| | | | | leaves of Copernicia prunifera palm, |
| | | | | consists mostly of aliphatic esters (40 wt %), |
| | | | | diesters of 4-hydroxycinnamic acid |
| | | | | (21.0 wt %), ω-hydroxycarboxylic acids |
| | | | | (13.0 wt %), and fatty alcohols (12 wt %) |
| | | | | (CAS No. 8015-86-9) |
| B2 | Vegetable wax | A. F. | Candellila | Natural wax obtained from the leaves of |
| | | Suter & | wax | Euphorbia cerifera and Euphorbia |
| | | Co Ltd UK | | antisyphilitica, comprised |
| | | | | predominately of n-alkanes (~50%), |
| | | | | which range from 29 to 33 carbons and |
| | | | | also contains 20-29% high molecular |
| | | | | weight esters, 12-14% alcohols and |
| | | | | sterols, and 7-9% free acids |
| | | | | (CAS No. 8006-44-8) |
| B3 | Mixed Natural | Koster | KKH NatWax | an ester composed of an ethylene glycol |
| | wax | Keunen | Alt 0154 | backbone and fatty acids in the C18-C36 |
| | | | | range; designed as a Candelilla wax |
| | | | | alternative |
| C | Fisher Tropsh | Deurex | Deurex ® T- | Crystalline wax with narrow C-chain |
| | wax | | 19 | distribution |

TABLE 2

| | | | | | | Needle |
|---|---|---|---|---|---|---|
| | | | Con- | Soften- | | pene- |
| | | | gealing/ | ing | Acid No. | tration |
| | | | Melting | point | (mgKOH/ | (0.1 mm |
| | MW | | temper- | (° C.) | g) | @25° C.) |
| | (g/ | Viscosity | ature | (ASTM | (ASTM | (ASTM |
| No. | mol) | (cp@° C.) | (° C.) | E-28) | D465) | D 1231) |
| A1 | | 500@140 | | 84 | 6 | |
| A2 | | 600@160 | | 101 | 12 | |
| A3 | | | 66-75 | | <0.1 | |
| A4 | | 10-20 | 79-89 | | 15-20 | 0 |
| | | @140 | | | | |
| A5 | 760 | 800@150 | | 90 | | |
| A6 | 850 | 1900@150 | | 100 | | |
| A7 | 1200 | 3000@150 | | 105 | | |
| A8 | | 13-19 | 76-82 | | | 14-18 |
| | | mm²/s | | | | |
| | | @100 | | | | |
| A9 | | 3-5@100 | 52-54 | | | 16-20 |
| A10 | | | 58-60 | | | 15-19 |
| B1 | | | 81-90 | | 2-7 | <1 |
| | | | (82-86) | | | |
| B2 | | 16-25 | 68.5-72.5 | | 12-22 | |
| | | @100 | | | | |
| B3 | | | 65-75 | | 5-15 | 2-4 |
| C | | 15@140 | 83-91 | | 0 | 6-9 |

“Acid No.”, which is also referred to herein as “acid number” or “acid value”, describes a measure of the amount of free acids (e.g., free fatty acids) in the wax substance. This value is expressed as the amount, in milligrams, of potassium hydroxide required to neutralize one gram of the wax substance.

Without being bound to any particular theory, it is assumed that wax substances that exhibit high acid values may provide improved for improved cohesion of the mold material formulation and improved adhesion to a dispensed cast material.

“Needle Penetration” is an assay used to determine the hardness of a wax substance.

Table 3 below presents exemplary tested mold material formulations. Amounts are indicated as weight percent (% wt.) of the total weight of the formulation. It is to be noted that many other formulations (dozens) were tested, and Table 3 below is to be regarded as non-limiting.

TABLE 3

| No. | A1 | A2 | A3 | A4 | A5 + A6 | A7 | A8 | A9 | A10 | B1 | B2 | B3 | C |
|---|---|---|---|---|---|---|---|---|---|---|---|---|---|
| I | 4 | | 24 | 24 | | | | | | 48 | | | |
| II | | | 24 | | 14.4 | 9.6 | | | | 52 | | | |
| III | | | | | | | | 50 | | | 50 | | |
| IV | | | | | 21 | | | 20 | 6 | | | | 53 |
| V | | 21 | | | | | 29 | | | | | | 50 |
| VI | | | | | | | | 51 | | | 49 | | 4 |
| VII | | | | | | | | ~64 | | | | ~33 | 2.55 |

### Example 2

### Characterization

The properties and performance of the tested formulations were determined as follows:

Curling: observed manually upon printing a layer of the mold material having a thickness of about 5 mm. (desirable value: minimal or null)

Thermal conductivity: according to ISO 22007-2:2008 or ISO 13787:2003 (desirable value: higher than 0.25, for example, from 0.25 to 0.5, W/m ° C.).

Viscosity at 70-90° C.: measured using Brookfield viscometer model DV2+ using Thermosel System for hotmelt materials (desirable value: from about 6 to about 15 centipoises, at 90° C.).

Surface tension: measured by Du Nouy ring method produced by Vetus Industrial Co. Ltd., Model: OBZY-203 (desirable value: from about 24 to about 30 dyne/cm).

Melting/congealing point: measured using an instrument like Buchi melting point apparatus M-565 (desirable value: from 50 to 80° C., or from 50 to 70° C.).

Softening point: according to ASTM E-28 (desirable value: between 35 and 50° C.).

Thermal stability: Determined by (e.g., visually) detecting deformation at the working conditions (desirable value: minimal or null).

Thermal linear expansion or shrinkage: according to the following procedure: Melt mold material at 110° C. is poured into a silicon mold (120×70×3 mm) and allowed to cool to room temperature. The length of the casted sheet is measured and compered to the mold size. Results are given in % linear shrinkage at 100 to 25° C. (desirable value: lower than 1%).

Cohesion (adhesion of a mold layer to another mold layer): Printing a selected mold shape of a few dozen layers of the tested formulation and observing uniformity, inspected disintegrations and/or delamination between the printed layers. (desirable value: minimal or null).

Adhesion (adhesion of a mold layer to a cast layer): Applying a thin layer of the tested mold formulation, melted at 110° C. onto a surface of a green body made of the cast material; cooling to temperature and observing adherence or adhesion failure of the mold material to the case material. (desirable value: minimal or nullified adhesion failure).

Flexural strength (rigidity): According to ASTM-790. Desirable value: at least 3 MPa or at least 4 MPa.

Machinability: A mold is printed, a layer of 100 microns is cut with a mechanical revolver cutter and residual mold on the cutter knifes is observed (desirable value: minimal or null).

Plasticity resistance: a mold sheet is prepared and heated up to 40° C. A manual force is applied on the sheet and its deformation and tendency to curl are observed. Desirable value: minimal or null.

Dissolvability in an organic solvent is determined by dissolving equal volumes of the mold material and the organic solvent, heating the mixture at a constant or changing temperature in a range of from room temperature, typically, of from 40° C. to 90-100° C., and observing if all of the mold material is dissolved (desirable value: at least 80% or at least 90%, preferably 100%, dissolution).

Thermolysis is determined by heating the mold material at a temperature in a range of from 180 to 600° C., and determining the presence of the mold material or of decomposition products thereof (desirable value: null).

The formulations presented in Table 3 above were tested in a mold cast process such as described in WO 2018/203331 or WO 2020/044336.

Formulation I failed to exhibit the desirable adhesion and cohesion.

Formula II exhibited a viscosity higher than 20 at 90° C., and an undesirably high linear thermal shrinkage of 3.3%.

Formulation III fails to exhibit the desirable cohesion.

Formulation IV exhibited high curling.

Formulation V failed to exhibit the desirable adhesion and exhibited an undesirably high linear thermal shrinkage of 2.2%.

Formulations VI and VII met all the desired criteria for adequate performance in the tested mold-cast process.

### Example 3

### Exemplary Organic Solvent-Based Sinterable Cast Material Formulations

The materials used to make up an exemplary formulation according to the present embodiments, containing stainless steel powder as the sinterable material, are presented in Table A below.

TABLE A

| Component | % wt. |
|---|---|
| Powder of a sinterable material | 85-95 |
| Binder material (total amount) | 1-2 |
| organic vehicle (total amount) | 4-10 |
| Thickening agent | 0.1-1 |
| Dispersant | 0.01-0.5 |

The powder of a sinterable material may include a powder of one or more of a metal, a ceramic and/or a glass. In some embodiments, the sinterable materials are sinterable at a temperature of at least 500° C., or at least 800° C., or at least 1000° C., so as to assure complete thermolization of the binder(s) before sintering.

By “sintering” it is meant causing a powder to from a coherent mass without melting it.

Exemplary sinterable glass materials include, but are not limited to, soda-lime-silica glasses, sodium borosilicate glasses, fused silica, and alumino-silicate glasses.

Exemplary sinterable ceramic materials include, but are not limited to, metal oxides such as titania, silica, zirconia, and alumina.

Exemplary sinterable metal materials include, but are not limited to, gold, platinum, copper, silver, zinc, aluminum, antimony, barium, beryllium, bismuth, boron, cadmium, calcium, cerium, cesium, chromium, cobalt, erbium, europium, gadolinium, gallium, germanium, hafnium, holmium, indium, iron, lanthanum, lead, lutetium, lithium, magnesium, manganese, molybdenum, neodymium, nickel, niobium, osmium, palladium, potassium, praseodymium, rhenium, rhodium, rubidium, ruthenium, samarium, scandium, silicon, sodium, strontium, tantalum, tellurium, terbium, thulium, tin, titanium, tungsten, vanadium, yttrium, ytterbium, and zirconium, including alloys containing a combination of two or more metals, such as, for example, brass, steel (e.g., stainless steel), and bronze.

In exemplary embodiments, the sinterable material is or comprises a stainless steel powder.

In some of any of the embodiments described herein, the powder has an average particles size which is no more than 50% of the thickness of the layer formed during the AM process as described herein. In exemplary embodiments, the average particles size ranges from 1 to about 100 microns, or from 1 to about 50 microns, or from 1 to about 20 microns, e.g., 5-15, or 5-10 microns, including any intermediate values and subranges therebetween.

In some of any of the embodiments described herein, the powder is characterized by a high particles size distribution (PSD), for example, higher than commonly used for binder jet or laser beam or electron beam additive manufacturing processes. For example d(50): 10 micron, cutoff: 45 microns. Without being bound by any particular theory, it is assumed that high PSD provides higher tapped density and a more dense packaging of the particles in the printed object.

By “binder material” it is meant a curable material, which can be cured (hardened) when exposed to heat or other curing energy or to a curing condition such as, for example, pH change. A binder material typically comprises one or more polymerizable material(s) and/or one or more polymeric material(s) which can undergo further polymerization (e.g., chain elongation) and/or cross-linking when exposed to a curing condition (e.g., curing energy such as heat) to thereby provide a hardened material.

In some embodiments of the present invention, the binder material comprises a polymeric material (e.g., polymeric acrylic materials).

According to the present embodiments, the binder material is selected so as to exhibit one or more, preferably two or more, and preferably all, of the following properties:
Low volume shrinkage (e.g., lower than 1%) when subjected to reduced pressure;
Low tendency to form film, e.g., a film forming temperature (TMF) higher than 5° C. or higher than 10° C., or higher than a temperature used when hardening the cast material is performed (e.g., under vacuum);
Tg of at least 30° C. or at least 40° C., or from 30 to 80° C. (for each binder included in the binder material);
Thermolizability at a temperature lower than a sintering temperature of the sinterable material, e.g., lower than 1000° C., preferably lower than 600° C., or lower than 500° C., but higher than a melting temperature of the mold material.

In some embodiments, the binder material comprises two or more different materials, each providing to the formulation one or more of the above properties. For example, one binder material can feature a high Tg, one binder material can feature high TMF, etc., such that the selected combination of binder materials and the relative amounts thereof provide the desired properties as defined herein for a binder material.

In exemplary embodiments, the binder comprises two or more binder materials.

In some of any of the embodiments described herein, the binder material or mixture of binder materials are selected so as to impart to the cast material properties such as stiffness, uniformity, resistance to crack formation during the hardening step and subsequent steps if performed, resistance to solvents used to remove the mold material.

In some of any of the embodiments described herein, one or more of the binder materials is, or each independently is, a (meth)acrylic polymer, poly-(meth)acrylic polymer or a styrene-acrylic copolymer.

In some of any of the embodiments described herein, one or more, or all, of the binder materials is dissolvable or at least dispersible in the organic vehicle included in the formulation, at room temperature or at the working (jetting) temperature.

In some of any of the embodiments described herein, one or more, or all, of the binder materials, are solid in room temperature.

In some of any of the embodiments described herein, one or more, or all, of the binder materials are not in a form of an emulsion.

Exemplary materials suitable for use as a binder material include, but are not limited to, solid binders, typically including acrylic and/or methacrylic polymers and/or copolymers, such as those marketed under the tradenames NeoCryl B-817, Neocryl-B-842, and Joncryl®682.

Exemplary materials suitable for use as a dispersant (a dispersing agent) include materials suitable for use with inorganic materials such as the metal powders described herein, in an organic medium. Suitable materials are in a form solid particles, with or without an organic medium. An exemplary dispersing agent comprises an anionic aliphatic ester, such as, for example, a material marketed under the tradename Efka® FA 4673.

Exemplary materials suitable for use a thickening agent (a thickener) include, but are not limited to, polymeric materials that are soluble in organic solvents, and which preferably, but not obligatory, can further act as a co-binder, for example, by exhibiting good adhesion to metals, wax materials, and the like. A non-limiting example a suitable thickening agent is a material marketed under the trade name Mowital® B 60 H by Kuraray (a polyvinyl butyral).

In some of any of the embodiments described herein, the organic vehicle comprises one or more organic materials.

In some of any of the embodiments described herein, at least one of the organic materials is characterized by an evaporation rate, as defined herein, of from 0.3 to 0.9, or from 0.3 to 0.8, or from 0.3 to 0.7, relative to n-butyl acetate.

Without being bound by any particular theory, it is assumed that such a relatively low evaporation rate allows using the formulation in a mold-cast AM process as described herein, such that at least a portion of the organic vehicle does not evaporate when the formulation is dispensed, yet, it evaporates quickly upon dispensing the formulation and subjecting it, for example, to hardening under heat and/or reduced pressure as described herein.

In some of any of the embodiments described herein, the organic vehicle is such that does not chemically interact with the binder material and/or with the mold material. In some embodiments, the organic vehicle does not dissolve the mold material.

An exemplary organic material usable to form the organic vehicle is Propylene Glycol Mono Methyl Ether (PM) CAS No. 107-98-2 (evaporation rate: 0.62). Other exemplary suitable solvents include, but are not limited to, propylene glycol propyl ether (PnP), Dipropylene glycol monomethyl ether (DPM), Propylene Glycol Methyl Ether Acetate (PMA), and any mixture thereof.

In exemplary embodiments, the organic vehicle comprises a mixture of two or more organic materials. In some of these embodiments, one of the organic materials features an evaporation rate as described hereinabove, and can be, for example, one or more of Propylene Glycol Mono Methyl Ether (PM) CAS No. 107-98-2, propylene glycol propyl ether (PnP), Dipropylene glycol monomethyl ether (DPM), Propylene Glycol Methyl Ether Acetate (PMA), and any mixture thereof; and another organic material has a high evaporation rate as described herein and can be, for example, a ketone-type or acetone-type organic material, such as, for example, methyl ethyl ketone.

In exemplary embodiments, a total amount of the one or more organic materials that feature an evaporation rate as described hereinabove is at least 30%, or at least 40%, or at least 50%, by weight, of the total amount of the organic vehicle.

An exemplary formulation according to some embodiments of the present invention comprises:

As a powder of sinterable material: Stainless steel 316L powder, featuring average particles size of 8-10 microns, e.g., d50: 9 microns, obtained from Huarui China.

As Binder materials—a mixture of NeoCryl B-817, Neocryl-B-842, and Joncryl®682, at a total amount of 1-2% by weight, and at a weight ratio of from about 1:1:1 to about 1:2:3. As a Dispersant—an anionic aliphatic ester as described herein.

As a thickening agent—a co-binder as described herein.

As an organic vehicle—a mixture of PM and 2-butanone (ethyl methyl ketone), at a ratio of from about 1:1 to 2:1.

The formulation of the present embodiments is prepared by mixing the components as described herein, preferably, but not obligatory, at room temperature.

### Example 4

### Additional Exemplary Organic Solvent-Based Sinterable Cast Material Formulations

In exemplary embodiments, the sinterable material is an oxygen-sensitive metal.

In exemplary embodiments, the sinterable material comprises one or more metal(s) that feature a high oxidation rate and/or a high affinity to oxygen.

Such metals are also referred to herein as “oxidizable” or as “oxygen sensitive”. Such metals include, for example, metals featuring relatively high oxophilicity, of at least 0.1, or of at least 0.2, or of at least 0.3, when determined based on the metal-oxygen bond enthalpy as described in Kasper P. Kepp, Inorg. Chem., 2016, 55, 9461-9470.

In exemplary embodiments, the sinterable material is or comprises a copper powder.

In exemplary embodiments, the sinterable material is or comprises a titanium powder.

Tables B and C present additional exemplary formulations 1-5, containing copper powders (Table B) and exemplary formulations 6-10, containing titanium powders (Table C), according to some embodiments of the present invention.

TABLE B

| | 1 | 2 | 3A | 3B | 4 | 5 |
|---|---|---|---|---|---|---|
| Copper powder | 93% | 94% | 93.5% | 93.5% | 94% | 94.5% |
| D50 22 μm | | | | | | |
| Isopropyl | | | | | 0.4% | |
| alcohol (IPA) | | | | | | |
| Dowanol PM | | | | | | 0.6% |
| Butyl Acetate | | | | | 1.2% | |
| n-Butanol | 4.1% | 3.0% | | | | |
| Propyl methyl | | | | | 2.2% | 3.0% |
| Ketone (PMK) | | | | | | |
| Methyl Ethyl | 2.0% | 1.7% | 1.8% | 1.9% | 0.8% | 0.4% |
| Ketone (MEK) | | | | | | |
| Methyl Iso | | | 3.7% | 3.8% | | |
| Butyl | | | | | | |
| Ketone (MIBK) | | | | | | |
| DISPER- | 0.1% | 0.1% | 0.2% | | 0.1% | 0.5% |
| BYK ®-111 | | | | | | |
| Ethyl Cellulose | 0.4% | | 0.4% | 0.4% | 0.3% | 0.2% |
| Paraloid ® B82 | | 0.5% | | | | |
| Butvar ® B72 | | 0.2% | | | | |
| Elvacite ® 2042 | | | 0.4% | 0.4% | 0.6% | 0.8% |
| Sum | 100.0% | 100.0% | 100.0% | | 100.0% | 100.0% |

TABLE C

| | 6 | 7 | 8 | 9 | 10 |
|---|---|---|---|---|---|
| Titanium powder | 86.6% | 86.9% | 88.3% | 88.0% | 87.9% |
| D50 12 μm | | | | | |
| Methyl Ethyl | 3.7% | 3.6% | 3.2% | 3.1% | 3.0% |
| Ketone (MEK) | | | | | |
| Propyl methyl | | 8.0% | | | 7.0% |
| Ketone (PMK) | | | | | |
| Methyl Iso Butyl | 7.9% | | 7.0% | 7.3% | |
| Ketone (MIBK) | | | | | |
| DISPERBYK ®- | 0.3% | 0.2% | 0.1% | 0.2% | 0.3% |
| 106 | | | | | |
| 151207 SAIB-100 | | | | 1.0% | 0.9% |
| 80% | | | | | |
| Elvacite ® 2042 | 0.8% | | 0.7% | | |
| Paraloid ® B-66 | | 0.9% | 0.1% | | |
| Butvar ® B-79 | | | | 0.4% | |
| Ethyl Cellulose | 0.7% | 0.4% | 0.6% | | 0.8% |
| | 100.0% | 100.0% | 100.0% | 100.0% | 100.0% |

In some of any of the embodiments described herein, the powder has an average particles size which is no more than 50% of the thickness of the layer formed during the AM process as described herein.

In some of any of the embodiments described herein, the average particles size (d50) is no more than 50 micrometer, or no more than 45 micrometers, or no more than 40 micrometer, or no more than 30 micrometer, or no more than 25 micrometer, or no more than 22 micrometer, or no more than 20 micrometer, or no more than 16 micrometer, or no more than 10 micrometer.

In exemplary embodiments, the average particles size (d50) ranges from 1 to about 100 micrometer, or from 1 to about 50 micrometer, or from 1 to about 20 micrometer, e.g., 5-15, or 5-micrometer, including any intermediate values and subranges therebetween.

According to some of any of the embodiments described herein, d50 values are as determined by laser diffraction measurements in accordance with ISO 13320.

Herein throughout, the term “micrometer” and “micron” are used interchangeably.

In some of any of the embodiments described herein, the powder is characterized by a high particles size distribution (PSD), for example, higher than commonly used for binder jet or laser beam or electron beam additive manufacturing processes. For example d(50): 10 micron, cutoff: microns. Without being bound by any particular theory, it is assumed that high PSD provides higher tapped density and a more dense packaging of the particles in the printed object.

According to some of any of the embodiments described herein, the sinterable powder comprises a plurality of particles, and at least a portion, and preferably most or all of the particle are generally shaped as spherical particles.

By “at least a portion” it is meant at least 20%, at least 30%, at least 40%, and preferably at least 50% or at least 60%, of the particles. By “most” it is meant at least 70%, or at least 80%, or at least 90%, or at least 95%, or at least 98%, or at least 99%, of the particles.

Powders generally comprising spherical particles as described herein can be obtained by methods known in the art, for example, by gas atomization or water atomization.

According to exemplary embodiments, the powder comprises gas-atomized spherical particles, for example, gas-atomized metal particles. According to some of these embodiments, the average particles size (d50) of the gas-atomized spherical particles ranges from 1 to about 100 micrometer, or from 1 to about 50 micrometer, or from 1 to about 20 micrometer, e.g., 5-15, or 5-micrometer, including any intermediate values and subranges therebetween.

In the gas atomization process, a metal powder having a generally spherical shape, high tap density and low oxygen content is produced.

The spherical shape of particles in the sinterable powder and their relatively small size provide for a good fluidity and a high metal loading in the final product, mainly due to a higher tap density, and may further allow practicing the sintering stage at lower temperatures, thus achieving higher strengths.

According to some of any of the embodiments described herein, at least one, or all, of the organic materials is/are characterized by an evaporation rate, as defined herein, of at least 0.3, or of at least 0.4, or of at least 0.5, relative to n-butyl acetate.

In some of any of the embodiments described herein, at least one of the organic materials is characterized by an evaporation rate, as defined herein, of from 0.3 to 0.9, or from 0.3 to 0.8, or from 0.3 to 0.7, relative to n-butyl acetate.

In some embodiments, the organic vehicle comprises at least one organic material that is characterized by an evaporation rate that ranges from 0.3 to 0.8, or from about 0.3 to about 0.65.

An evaporation rate, as used herein, refers to n-butyl acetate as the reference material.

According to some of any of the embodiments described herein, the at least one organic material has an evaporation rate in a range of from 0.3 to 0.8, or from 0.3 to 0.7, or from 0.4 to 0.8, or from 0.4 to 0.7, or from 0.5 to 0.7, on an n-butyl acetate scale.

An exemplary organic material usable to form the organic vehicle is Propylene Glycol Mono Methyl Ether (PM) CAS No. 107-98-2 (evaporation rate: 0.62). Other exemplary suitable solvents include, but are not limited to, propylene glycol propyl ether (PnP), dipropylene glycol monomethyl ether (DPM), propylene glycol methyl ether acetate (PMA), and any mixture thereof.

An exemplary organic material usable to form the organic vehicle is n-butanol.

In exemplary embodiments, the organic vehicle comprises a mixture of two or more organic materials. In some of these embodiments, one of the organic materials features an evaporation rate as described hereinabove, and can be, for example, one or more of Propylene Glycol Mono Methyl Ether (PM) CAS No. 107-98-2, propylene glycol propyl ether (PnP), Dipropylene glycol monomethyl ether (DPM), Propylene Glycol Methyl Ether Acetate (PMA), and any mixture thereof; and another organic material has a high evaporation rate as described herein and can be, for example, a ketone-type or acetone-type organic material as described hereinafter, such as, for example, methyl ethyl ketone.

In exemplary embodiments, a total amount of the one or more organic materials that feature an evaporation rate that ranges from 0.3 to 0.8 as described hereinabove is at least 30%, or at least 40%, or at least 50%, by weight, of the total amount of the organic vehicle.

According to some of any of the embodiments described herein, the organic vehicle comprises at least one organic material that has an evaporation rate in a range of from 0.3 to 0.8 on an n-butyl acetate scale, as described herein, and at least one organic material that has an evaporation rate higher than 2 or higher than 3.

According to some of these embodiments, an amount of the organic material that features a low evaporation rate as described herein (e.g., an alkylene glycol) is at least 50%, by weight of the total amount of the organic vehicle.

According to some embodiments, a weight ratio of an organic material with low evaporation rate and an organic material with high evaporation rate ranges from 1:1 to 3:1, or from 1:1 to 2:1, including any intermediate values and subranges therebetween.

According to some of any of the embodiments described herein, the one or more organic materials that form the organic vehicle are such that vaporize at both atmospheric and reduced pressure. Preferably, the one or more organic materials that form the organic vehicle feature a boiling temperature that is lower than 190° C.

Exemplary organic materials that are usable for forming the organic vehicle include, but are not limited to, alcohols, alkanes, diols, ketones, acetates, esters, glycol ethers, glycol esters and any mixture thereof.

Exemplary alcohols that are usable in the context of the respective embodiments of the present invention include, but are not limited to, C1-C5 alcohols, such as ethanol, isopropyl alcohol, and t-butanol.

Exemplary alkanes that are usable in the context of the respective embodiments of the present invention include, but are not limited to, heptane, 2,3-dimethylbutane, 2,2-dimethylbutane, 2-methylpentane and 3-methylpentane.

Exemplary alcohols that are usable in the context of the respective embodiments of the present invention include, but are not limited to, esters of liquid C1-C10 carboxylic acids and C1-C8 alcohols such as methyl acetate, ethyl acetate, propyl acetate, n-butyl acetate, isoamyl acetate, methyl formate and 3-ethoxyl ethyl propionate.

Exemplary ketones that are usable in the context of the respective embodiments of the present invention include, but are not limited to methyl ethyl ketone (MEK), methyl propyl ketone (MPK), methyl iso-butyl ketone (MIBK), diisobutyl ketone, isophorone, ketohexamethylene and acetone.

Exemplary ethers that are usable in the context of the respective embodiments of the present invention include, but are not limited to, dimethoxymethane, diethoxyethane or diethyl ether; glycol ethers such as butoxy ethanol, butyldiglycol, methyl carbitol, propylene glycol n-butyl ether and propylene glycol methyl ether acetate;

Additional exemplary organic materials include, for example, volatile hydrocarbon, such as C8-C16 isoalkane (isoparaffin), Fancol ID, isodecane, and the oil marketed under the trade name Isopar® or Permethyl®, and mixtures thereof, methyl formate, and Parachlorobenzotrifluoride (PCBTF).

In some of any of the embodiments described herein, the organic vehicle is such that does not chemically interact with the binder material and/or with the mold material. In some embodiments, the organic vehicle does not dissolve the mold material.

According to some of any of the embodiments described herein, the organic vehicle comprises an alkylene glycol, typically as an organic material that features a low evaporation rate as described herein, for example, an alkylene glycol having the formula:

RaO—[(CR′R″)_{z}—O]_{y}-Rb

with Ra, Rb, R′ and R″ being each independently hydrogen, alkyl, cycloalkyl, or aryl, and with z being an integer of from 1 to 10, preferably, 2-6, more preferably 2 or 3, and y being an integer of 1 or more. Preferably R′ and R″ are both hydrogen. Preferably, one or both of Ra and Rb is an alkyl. When z is 2 and y is 1, this group is an ethylene glycol. When z is 3 and y is 1, this group is a propylene glycol.

According to exemplary embodiments, the organic vehicle comprises a propylene glycol, and in some embodiments it comprises a propylene glycol methyl ether.

Other organic materials having an evaporation rate as defined herein are contemplated as included in the organic vehicle.

According to exemplary embodiments, the organic vehicle comprises a mixture of an alkylene glycol as described herein and a ketone-type material, as an organic material that has high evaporation rate, for example, an acetone type material of the formula:

Rx-C(═)-Ry

Wherein Rx and Ry are each independently an alkyl, preferably a lower alkyl of 1-6, or 1-4, carbon atoms on length.

In some embodiments, one of Rx and Ry is methyl and the other is ethyl, propyl, or butyl.

According to some of any of the embodiments described herein, the organic vehicle comprises an alkylene glycol.

According to some of any of the embodiments described herein, the organic vehicle comprises a mixture of an alkylene glycol and a ketone, as described herein.

According to some of any of the embodiments described herein, a total amount of the organic vehicle ranges from 3 to 10, or from 4 to 10, % by weight of the total weight of the formulation.

According to some of any of the embodiments described herein, a total amount of the organic vehicle ranges from 3 to 10, or from 4 to 10, or from 4 to 8, or from 4 to 7, % by weight of the total weight of the formulation, including any intermediate values and subranges therebetween.

According to some of any of the embodiments described herein, an amount of the binder material is no more than 10%, or no more than 5%, or no more than 3%, or no more than 2%, by weight of the total weight of the formulation.

In some embodiments, an amount of the binder material ranges from 0.8 to 2% by weight of the total weight of the formulation, including any intermediate values and subranges therebetween.

In some embodiments of the present invention, the binder material comprises a polymeric material (e.g., polymeric acrylic materials).

According to some of any of the embodiments described herein, the binder material is selected so as to exhibit one or more, preferably two or more, and preferably all, of the following properties:
Low volume shrinkage (e.g., lower than 1%) when subjected to reduced pressure;
Low tendency to form film, e.g., a film forming temperature (TMF) higher than 5° C. or higher than 10° C., or higher than a temperature used when hardening the cast material is performed (e.g., under vacuum);
Tg of at least 25° C., or at least 30° C. or at least 40° C., or from 25 to 150° C., or from 25 to 100° C., or from 25 to 80° C., or from 30 to 150° C., or from 30 to 100° C., or from 30 to 80° C. (for each binder included in the binder material);
Thermolizability at a temperature lower than a sintering temperature of the sinterable material, e.g., lower than 1000° C., preferably lower than 600° C., or lower than 500° C., but higher than a melting temperature of the mold material.

According to some of any of the embodiments described herein, one or more, preferably all, of the binder material independently features a glass transition temperature (Tg) of at least 25° C. According to some of any of the embodiments described herein, one or more, preferably all, of the binder material independently features a glass transition temperature (Tg) that ranges from 25 to 150° C., including any intermediate values and subranges therebetween.

In some embodiments, the binder material comprises two or more different materials, each providing to the formulation one or more of the above properties. For example, one binder material can feature a high Tg, one binder material can feature high TMF, etc., such that the selected combination of binder materials and the relative amounts thereof provide the desired properties as defined herein for a binder material.

In exemplary embodiments, the binder comprises two or more binder materials.

In some of any of the embodiments described herein, the binder material or mixture of binder materials are selected so as to impart to the cast material properties such as stiffness, uniformity, resistance to crack formation during the hardening step and subsequent steps if performed, resistance to solvents used to remove the mold material.

In some of any of the embodiments described herein, one or more of the binder materials is, or each independently is, a (meth)acrylic polymer, poly-(meth)acrylic polymer or a styrene-acrylic copolymer.

In some of any of the embodiments described herein, one or more, or all, of the binder materials is dissolvable or is at least dispersible in the organic vehicle included in the formulation, at room temperature or at the working (jetting) temperature.

In some of any of the embodiments described herein, one or more, or all, of the binder materials, are solid at room temperature.

According to some of any of the embodiments described herein, the binder material is not in a form of an emulsion.

According to some of any of the embodiments described herein, the binder material is devoid of water.

According to some of any of the embodiments described herein, the binder material is thermolizable at a temperature lower by at least 100° C. than a sintering temperature of the sinterable material, so as to assure complete thermolization of the binder material during the debinding stage and/or to assure that no binder material remains when the brown body is subjected to sintering.

According to some of any of the embodiments described herein, the binder material remains intact when subjected to a condition under which the mold material is removed. For example, the binder material is non-dissolvable when contacted with an organic solvent that dissolves the mold material and/or at a melting temperature of the mold material.

According to some of any of the embodiments described herein, a volume shrinkage of the binder material when subjected to reduced pressure of about 5 mbars is less than 1%.

According to some of any of the embodiments described herein, the binder material has an (e.g., average) Tg of at least 30° C., or of at least 40° C.

According to some of any of the embodiments described herein, the binder material comprises a mixture of two or more binders, and a Tg of each of these binders ranges from 30 to 80° C.

According to some of any of the embodiments described herein, the binder material is characterized by a film forming temperature (TMF) of at least 0° C., or at least 5° C. or of at least 10° C. In some embodiments the TMF is in a range of from 0 to 10° C. In some embodiments, the TMF does not exceed the temperature at which the organic vehicle evaporates under reduced pressure.

In some of any of the embodiments described herein, the binder is or comprises a (meth)acrylic polymer, that is an acrylic and/or methacrylic polymer or co-polymer. An acrylic copolymer can be, for example, a co-polymer comprising acrylic/methacrylic backbone units and aromatic backbone units such as styrene backbone units.

Exemplary materials suitable for use as a binder material include, but are not limited to, solid binders, typically including acrylic and/or methacrylic polymers and/or copolymers, such as those marketed under the tradenames NeoCryl B-817, Neocryl-B-842, and Joncryl®682. Additional exemplary binder materials include, but are not limited to, ethyl cellulose polymers (such as marketed under the trade name Etocel®Dupont), Cellulose Acetate Butyrate polymers (such as marketed as CAB, by Eastman), Polyvinyl butyral polymers (such as marketed under the trade name Butvar® by Eastman), Poly vinyl pyrrolidone polymers (such as marketed by Ashalnd), poly(methyl methacrylate) and copolymers thereof, polymethacrylate and copolymers thereof, poly(ethyl methacrylate) and copolymers thereof, poly(butyl methacrylate) and copolymers thereof, poly(isobutyl methacrylate) and copolymers thereof (such as marketed under the tradename Elvacite® by Lucite; or Paraloid® by Dow), polystyrene maleic anhydride and copolymers thereof (such as marketed under the trade name SMA® by Cray Valley), Urea-aldehyde resins (such as marketed under the tradename Laropal® by BASF), Sucrose Acetate Iso-butyrate polymers (such as marketed under SAIB® by Eastman) and Nitrocellulose polymers (such as marketed by Hagedorn, Germany).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A mold material formulation usable as forming a mold material in a cast-mold process in combination with a cast material formulation, the mold material formulation comprising:
Microcrystalline paraffin wax featuring a viscosity lower than 1000 cps at 90° C. and a melting temperature lower than 70° C. or lower than 60° C., in an amount of from about 40 to about 70 weight percent of the total weight of the formulation;
Vegetable-based (natural) wax featuring a low thermal expansion coefficient and high thermal conductivity, and optionally featuring an acid number higher than 1, or higher than 2, or higher than 5; in an amount of from about 30 to about 50 weight percent of the total weight of the formulation; and
Fisher-Tropsh wax, in an amount of from about 1 to about 10 weight percent of the total weight of the formulation.

2. The mold material formulation of claim 1, wherein said microcrystalline paraffin wax features a melting point range lower than ° C. and/or an acid number lower than 2.

3. (canceled)

4. The mold material formulation of claim 1, wherein said vegetable-based wax features a linear thermal expansion lower than 1%, when determined by a method as described herein in the Examples section and/or thermal conductivity higher than 0.25, or higher than 0.30 or higher than 0.40 and/or an acid number higher than 10.

5-7. (canceled)

8. The mold material formulation of claim 1, wherein an amount of said Fisher-Tropsh wax ranges from 2 to 8, weight percent of the total weight of the formulation.

9. The mold material formulation of claim 1, characterized by a Viscosity in a range of from about 6 to about 15 centipoises, at a temperature in a range of from 70 to 90° C.; and as providing a mold material that is characterized by at least one, or at least two, or at least three, or at least four, or all, of the following characteristics:
Melting point lower than 80° C.;
Melting point range lower than 10° C.;
Softening point in a range of from 35 to 50° C.;
Linear thermal expansion at 25-100° C. lower than 0.5%;
Thermal conductivity of at least 0.25;
Cohesion;
High Flexural strength;
Dissolvability in an aliphatic hydrocarbon solvent; and
Thermolysis at a temperature that ranges from 180 to 600° C.

10. The mold material formulation of claim 9, further characterized by one or more of the following characteristics:
Surface tension in a range of from about 24 to about 30 dyne/cm;
being devoid of solid particles having a diameter higher than 2 microns, or higher than 1 micron; and
Chemical inertness and stability during the mold-cast process.

11. The mold material formulation of claim 9, wherein the mold material provided by the formulation is further characterized by one or more of the following characteristics:
Machinability at the mold-cast process conditions;
Plasticity resistance at the mold-cast process conditions;
Adhesion to a cast material usable in the mold-cast process; and
Low curling.

12. The mold material formulation of claim 1, usable in forming a mold in a configured pattern in an additive manufacturing process such as 3D inkjet printing.

13. A method of forming a three-dimensional object, the method comprising:
forming a mold according to a shape of the object, using a mold material formulation of claim 1;
filling the mold with a cast material formulation, to thereby obtain a mold-cast product; and
removing the mold from said mold-cast product, to thereby obtain the object.

14. The method of claim 13, wherein said filling comprises pouring said cast material formulation into said mold or injection molding of said cast material formulation into said mold.

15. (canceled)

16. The method of claim 13, wherein said filling comprises using a squeegee pressed against the mold to spread said cast material formulation into said mold, or wherein said filling comprises using a blade spaced from the mold surface to spread said cast material formulation into said mold.

17. The method of claim 13, wherein removing said mold comprises immersion in an organic solvent at a temperature in a range of from 30 to 100° C.

18. (canceled)

19. The method of claim 13, further comprising, prior to removing said mold, hardening said mold-cast product.

20. The method of claim 13, wherein forming said mold comprises forming a layered mold by dispensing a plurality of layers of said mold material formulation in a configured pattern corresponding to the shape of the object.

21. The method of claim 20, comprising:
printing a first layer of said mold material to define one layer of said layered mold;
filling said first mold with said cast material formulation, thereby forming a first mold-cast layer;
printing a second layer of said mold on top of said first mold-cast layer to define a second layer of said layered mold; and
filling said second layer, over said first layer, with said cast material formulation.

22. (canceled)

23. The method of claim 21, further comprising, subsequent to said filling, hardening said mold-cast layer.

24. The method of claim 23, wherein said hardening comprises subjecting the mold-cast layer or object to a reduced pressure for a pre-determined time period.

25. (canceled)

26. The method of claim 24, wherein said reduced pressure ranges from 0.01 millibar to 100 milliBar, or from 0.1 millibar to 25 millibar, or about one millibar.

27. (canceled)

28. The method of claim 13, wherein said cast material formulation comprises a sinterable material.
